(19) United States
(12) Patent Application Publication
(10) Pub. No.: US 2018/0248836 A1
(43) Pub. Date: Aug. 30, 2018

(54) SOCIAL COMMUNICATIONS SYSTEMS AND METHODS

(71) Applicant: Razi Islam, Perth, Western Australia (AU)

(72) Inventor: Razi Islam, Perth, Western Australia (AU)

(21) Appl. No.: 15/757,961

(22) PCT Filed: Sep. 7, 2016
(86) PCT No.: PCT/AU2016/050843

§ 371 Date: Mar. 6, 2018

(30) Foreign Application Priority Data
Sep. 7, 2015 (AU) 2015903649
Mar. 9, 2016 (AU) 2016900875

(51) Int. Cl. H04L 12/58; G06F 17/30

(52) U.S. Cl. CPC H04L 51/32; G06Q 50/01; G06F 17/30876

(57) ABSTRACT

In one preferred form of the present invention, there is provided a social communications system 10. The system 10 includes a message facility 12 configured to encourage the creation of positive messages 14 that provide positive affirmation or appreciation messages 14 from a number of system users 16. The message facility 16 is configured to limit the creation of negative messages 18 from system users 16 that would denigrate system users or other people; the message facility 12 including a forms facility 20 for assisting the system users 16 with the construction of the positive messages 14.

### INCORPORATION BY REFERENCE

The present invention claims priority from and incorporates the following applications by reference for all purposes: (i) Australian Application 2016900875 ‘entitled SOCIAL COMMUNICATIONS SYSTEMS AND METHODS’ in the name of Islam, Razi and filed Mar. 9, 2016; and (ii) Australian Application 2015903649 entitled ‘SOCIAL COMMUNICATIONS SYSTEMS AND METHODS’ in the name of Islam, Razi and filed Sep. 7, 2015.

### FIELD OF THE INVENTION

The present invention relates to social communications systems and methods.

### BACKGROUND To THE INVENTION

Social networking systems and methods have provided users with the ability to readily broadcast and share information. In some instances users have been provided with increased anonymity.

The problems associated with conventional social networking systems and methods include: (i) the ability for users to disseminate disparaging comments about other users to a wide audience; (ii) cyberbullying of individuals; (iii) impersonation of individuals and companies; and (iv) disseminating misleading information about individuals and companies.

It is against this background and the problems and difficulties associated therewith that the inventor has developed the present invention.

### SUMMARY OF THE INVENTION

According to a first aspect of preferred embodiments herein described there is provided a computer implemented social communications system comprising: a message facility configured to encourage the creation of positive messages that provide affirmation or appreciation messages from system users; the message facility being configured to limit the creation of negative messages from the system users that would denigrate the system users or external parties; the message facility including a forms facility for assisting the system users with the construction of the positive messages.

Preferably the social communications system includes a calculation facility for calculating scores relating to the positive messages sent by the system users using the message facility.

Preferably the social communications system includes a display facility for displaying the scores relating to the positive messages sent by the system users.

Preferably the social communications system includes a calculation facility for calculating scores relating to the number of unnoticed associated users that are associated with each system user; each unnoticed associated user being unnoticed by the system user for a predetermined period due to no positive messages being sent by the system user to the unnoticed associated user.

Preferably the social communications system includes a display facility for displaying the number of unnoticed associated users, associated with each system user, to the system user.

Preferably the social communications system includes a calculation facility for calculating trending scores for each system user, the trending scores relating to the positive messages sent by the system user using the message facility; the trending scores relating to the system users associated with each system user who have sent the most messages.

Preferably the social communications system includes a calculation facility for calculating trending scores for each system user relating to the positive messages sent by the system users using the message facility; the trending scores relating to the system users associated with each system user who have received the most messages.

Preferably the social communications system includes an encouragement facility that proactively sends the system users messages seeking the creation of positive messages.

Preferably the social communications system wherein the forms facility provides the ability for a user to select an introductory set of words that that provide an introduction to a positive affirmation or appreciation note.

Preferably the social communications system includes a selector providing the ability for a user to select an image or video to form part of the positive affirmation or appreciation message.

Preferably the forms facility is configured to tailor the affirmation or appreciation message based on data associated with a selected image or video.

According to an aspect of preferred embodiments herein described there is provided a computer implemented social communications system for number of system users, the system including a calculation facility for calculating scores relating to the number of unnoticed associated users that are associated with each system user, each unnoticed associated user associated with a system user, being unnoticed by the system user.

Preferably each unnoticed associated user associated with each system user, is unnoticed by the system user for a predetermined period of time due to no positive messages being sent by the system user to the unnoticed associated user.

Preferably associated users of a system user constitute electronic ‘friends’ of the system user, the associated users having accepted a ‘friend’ request.

Preferably an unnoticed associated user of each system user is defined as being unnoticed for a predetermined period of time, due to no positive messages being sent by the system user to the unnoticed associated user.

Preferably the predetermined period of time is 1 week.

According to an aspect of preferred embodiments herein described there is provided a computer implemented social communications system for a number of system users, the system including an unnoticed friends indicator for showing how many friends of a system user have been unnoticed by the system user.

Preferably wherein each unnoticed associated user of each system user is defined as being unnoticed for a predetermined period of time, due to no positive messages being sent by the system user to the unnoticed associated user.

According to a an aspect of preferred embodiments herein described there is provided a computer implemented social communications method comprising: encouraging the creation of positive messages, with the use of a message facility, to provide affirmation or appreciation messages from users; the method including limiting the creation or transmission of negative messages from the users, the negative messages operating to denigrate the users or other people; and using a forms facility to assist the users with the construction of the positive messages.

Preferably the computer implemented social communications method includes calculating scores relating to the positive messages sent by the users using the message facility.

Preferably the computer implemented social communications method includes displaying the scores relating to the positive messages sent by the users.

Preferably the computer implemented social communications method includes calculating scores relating to the number of unnoticed associated users associated with each user; each unnoticed associated user being unnoticed by the user for a predetermined period due to no positive messages being sent by the user to the unnoticed associated user.

Preferably the computer implemented social communications method includes displaying the number of unnoticed associated users, associated with each system user, to the user.

Preferably the computer implemented social communications method includes calculating trending scores for each user, the trending scores relating to the positive messages sent by the user using the message facility; the trending scores relating to the users associated with each user who have sent the most messages.

Preferably the computer implemented social communications method includes calculating trending scores for each system user relating to the positive messages sent by the users using the message facility; the trending scores relating to the users associated with each system user who have received the most messages.

Preferably the computer implemented social communications method includes providing the ability for a user to select an introductory set of words that that provide an introduction to a positive affirmation or appreciation note.

Preferably the method includes providing the ability for a user to select an image or video to form part of the positive affirmation or appreciation message.

Preferably the method includes tailoring the affirmation or appreciation message based on data associated with a selected image or video.

According to an aspect of preferred embodiments herein described there is provided a computer implemented social communications method for a number of system users, the method including calculating scores relating to the number of unnoticed associated users that are associated with each system user, each unnoticed associated user associated with a system user being unnoticed by the system user.

Preferably each unnoticed associated user associated with each system user, is unnoticed by the system user for a predetermined period of time due to no positive messages being sent by the system user to the unnoticed associated user.

Preferably associated users of a system user constitute electronic ‘friends’ of the system user, the associated users having accepted a ‘friend’ request.

Preferably an unnoticed associated user of each system user is defined as being unnoticed for a predetermined period of time, due to no positive messages being sent by the system user to the unnoticed associated user.

Preferably the predetermined period of time is 1 week.

According to an aspect of preferred embodiments herein described there is provided a computer implemented social communications method for a number of system users, the method including showing on an indicator how many friends of a system user have been unnoticed by the system user.

Preferably each unnoticed associated user of each system user is defined as being unnoticed for a predetermined period of time, due to no positive messages being sent by the system user to the unnoticed associated user.

According to an aspect of preferred embodiments herein described there is provided a computer implemented social communications system comprising: a teacher facility for providing system users with teacher accounts; a student facility for providing system users with student accounts; a message facility configured to encourage the creation of positive messages that provide affirmation or appreciation messages from system users; the message facility being configured to limit the creation of negative messages from the system users that would denigrate the system users or external parties; the message facility including a forms facility for assisting the system users with the construction of the positive messages.

Preferably the system includes a flag facility allowing the user of a teacher account to flag an inappropriate message created by a user of a student account and to share the flag with another teacher account that is associated with the student account.

Preferably the system includes a flag facility allowing the user of a teacher account to flag an inappropriate message created by a user of a student account and to share the flag with a parent account that is associated with the student account.

Preferably the system includes a calculation facility for calculating scores relating to the positive messages sent by the system users using the message facility; wherein users are able to use the message facility to select whether to create positive messages for a teacher account or a student account; and the calculation facility is configured to calculate a different score based on the positive message being for a teacher account or for a student account.

Preferably the system includes a calculation facility for calculating scores relating to the positive messages sent by the system users using the message facility; wherein a teacher is provided with the to award additional points for exceptional affirmation messages.

Preferably the system includes a sort facility allowing a teacher to sort student data in ascending or descending order based on messages awaiting approval.

Preferably the system includes a sort facility allowing a teacher to sort student data in ascending or descending order based on messages sent, received or awaiting approval to assist the teacher to detect any signs of isolation or social development issues.

Preferably the system includes a notes facility allowing the user of a teacher account to store one or more comments in connection with a message created by the user of a student account.

Preferably the system includes a merit facility with the use if which a teacher is able award points for exceptional affirmation messages and share those affirmation messages with parents.

According to an aspect of preferred embodiments herein described there is provided a computer readable medium having stored thereon computer executable instructions for performing a computer implemented method as claimed in any one of the preceding method claims.

According to an aspect of preferred embodiments herein described there is provided a computer readable medium having stored thereon computer executable instructions encoding a computer implemented system as claimed in any one of the preceding system claims.

According to an aspect of preferred embodiments herein described there is provided a computer implemented system substantially as herein described with reference to the accompanying drawings.

According to an aspect of preferred embodiments herein described there is provided a computer implemented method substantially as herein described with reference to the accompanying drawings.

Various embodiments described herein are considered to provide for positive affirmations and appreciation notes in an advantageous way. The various embodiments are considered to provide a new and inventive type of social network. The encouragement of positive affirmations and appreciation notes is considered to provide a shift in the context and thinking of existing systems.

It is to be recognised that other aspects, preferred forms and advantages of the present invention will be apparent from the specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides a schematic view of a social communications system according to a first preferred embodiment of the present invention.

FIG. 2 provides an illustration of a graphical user interface of the social communications system shown in FIG. 1.

FIG. 3 provides an illustration of a graphical user interface of the social communications system shown in FIG. 1.

FIG. 4 provides an illustration of a notification sent by the social communications system shown in FIG. 1.

FIG. 5 provides an illustration of a graphical user interface of the social communications system shown in FIG. 1.

FIGS. 6a and 6b provides two illustrations of a graphical user interface of the social communications system shown in FIG. 1.

FIG. 7 provides an illustration of a graphical user interface of the social communications system shown in FIG. 1.

FIG. 8 provides a schematic view of a computer based social communications method according to a second preferred embodiment of the present invention.

FIG. 9 provides an illustration in connection with the computer based social communications method shown in FIG. 8.

FIG. 10 provides a schematic flow diagram in connection with the computer based social communications method shown in FIG. 8.

FIG. 11 provides a schematic flow diagram in connection with the computer based social communications method shown in FIG. 8.

FIGS. 12 to 15 provide an illustration of a system a further preferred embodiment of the present invention; the system providing a student social communications platform.

FIGS. 16 to 20 illustrate a number of graphical user interfaces according to preferred embodiments of the present invention.

FIGS. 21a to 29b provide several views of a further preferred embodiment of the present invention.

FIG. 30 provides a schematic flow diagram in connection with a further preferred embodiment of the present invention.

FIG. 31 provides an illustration of a system according to a further preferred embodiment of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

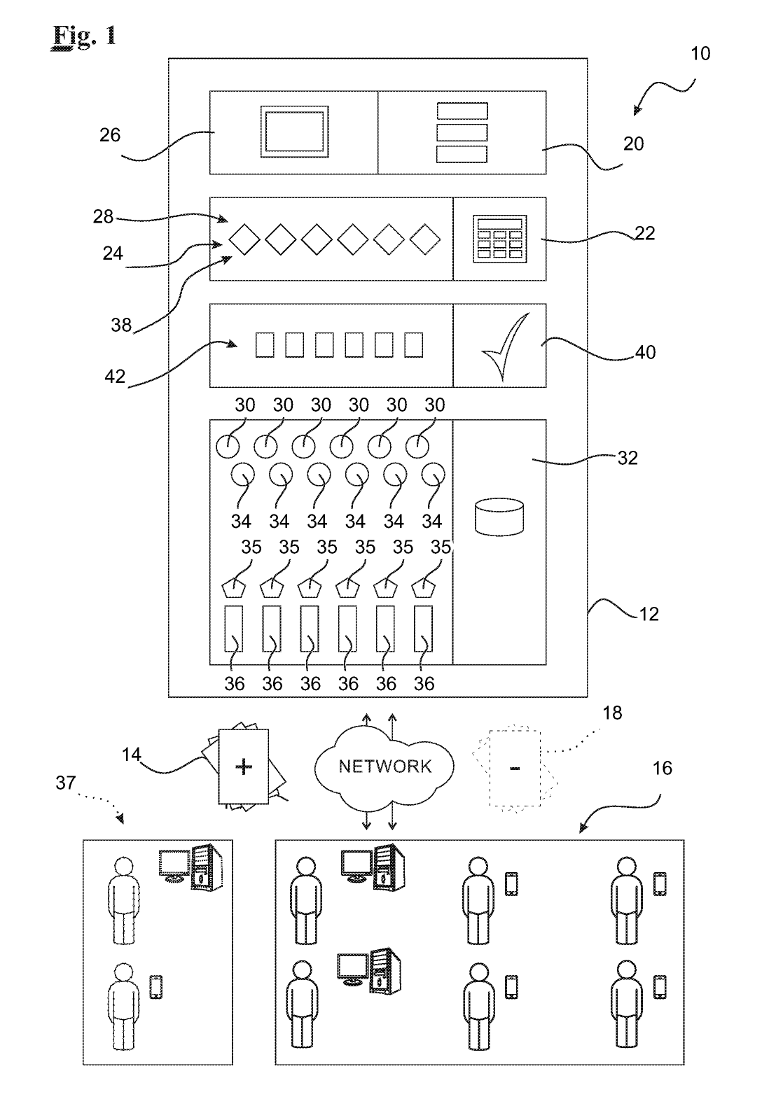

Referring to FIG. 1 there is shown a computer implemented social communications system 10 according to a first preferred embodiment of the present invention. The social communications system 10 includes a message facility 12 that is configured to encourage the creation of positive messages 14 that provide positive affirmation or appreciation messages 14 from system users 16. Notably the social communications system provides for both social networking and social development. The term social development provides a different context to current social networking in the sense of the configuration of the message facility and the creation of the positive messages 14.

The message facility 12 is configured to limit the creation or transmission of negative messages 18 from system users 16 that would denigrate system users 16 or other people. The message facility 12 includes a forms facility 20 for assisting system users 16 with the construction of the positive messages 14.

The social communications system 10 includes a calculation facility 22 for calculating scores 24 relating to the positive messages 14 sent by the system users 16 using the message facility 12. The system 10 includes a display facility 26 for displaying the scores 24 relating to the positive messages 14 sent by the system users 16. As will be described different indicators are preferably used to display statistics of sent positive messages 14 in various graphical user interfaces provided by the system 10. The calculation facility is also provided for calculating scores relating to the positive messages 14 received by the system users 16. The display facility 26 is also provided for displaying such scores.

In addition, the calculation facility 22 is provided to calculate scores 28 relating to the number of unnoticed associated users 30 of each system user 16. An unnoticed associated user 30 of each system user 16 is defined as being unnoticed during a predetermined period of time (in this embodiment 1 week), due to no positive messages 14 being sent by the system user 16 to the unnoticed associated user 30.

The calculation facility 22 is provided to calculate the number of associated inactive associated system users 35 who have been inactive for a predetermined period of time. The inactive associated users 35 in the user network of each user 16 is shown to the user 16. This encourages the user 16 to notice the associated inactive users 35. The inactive associated users 35 are inactive in the sense of not having sent any positive messages 14 to any users 16 for the predetermined period of time.

The display facility 26 displays the number unnoticed associated users 30 of each system user 16 in a dashboard (not shown) to the system user 16. This serves to encourage system users 16 to send positive messages 14 to their unnoticed associated users 30. Associated users 30 may constitute electronic ‘friends’ of the system user 16, the associated users 30 having accepted a ‘friend’ request.

Once a positive message is sent the unnoticed associated user 30 becomes a noticed associated user 34. Data concerning the unnoticed associated users 30 and noticed associated users 32 of each user 16 is stored in a database facility 32. The database facility 32 stores both data in relation to unnoticed associated users 30 and the noticed associated users 34 for each system user 16.

The database 32 also stores system user information 36 relating to each user 16. The system user information 36 includes information such as the fields of expertise, qualifications, work history and other information commonly stored in social networks.

The calculation facility 22 calculates trending scores 38 for each system user 16 relating to the positive messages 14 sent or received by the system user 16. The trending scores 38 relate to those system users 16, that are associated with each system user 16, who has sent the greatest number of positive messages 14.

In other embodiments the trending scores may relate to who has received the greatest number of positive messages 14. Trending scores may be shown for users 16 inside each user's associated user network and also for users external thereto. Notably users 16 are able to send positive messages 14 to users 16 and external parties 37 who are not registered as system users 16 in the system 10. This encourages new users to register with the system 10.

The social communications system 10 includes a proactive encouragement facility 40 that proactively sends the system users 16 a number messages 42 seeking the creation and subsequent transmission of positive messages 14. In this embodiment messages are stored in the database 32 with notifications being sent to users 16, 37 by email. Other modes of communication such as SMS are of course possible.

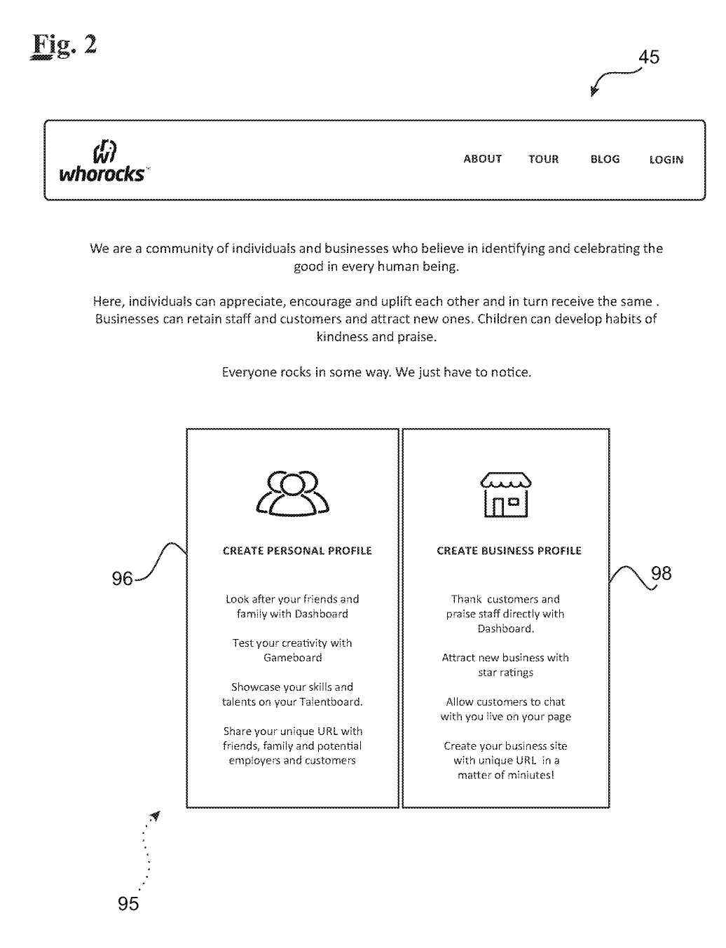

Referring to FIG. 2 there is shown an illustration an interface 45 provided by the social communications system 10. The system 10 provides a membership registration facility 95 allowing users to register in the system 10. In order to register as a system user 16, a personal profile creation area 96 or a business profile area 98 can be accessed with the use of the interface 45 provided by the system 10. Once an email address of the personal or business user account has been verified, the personal or business user is able to access the system 10.

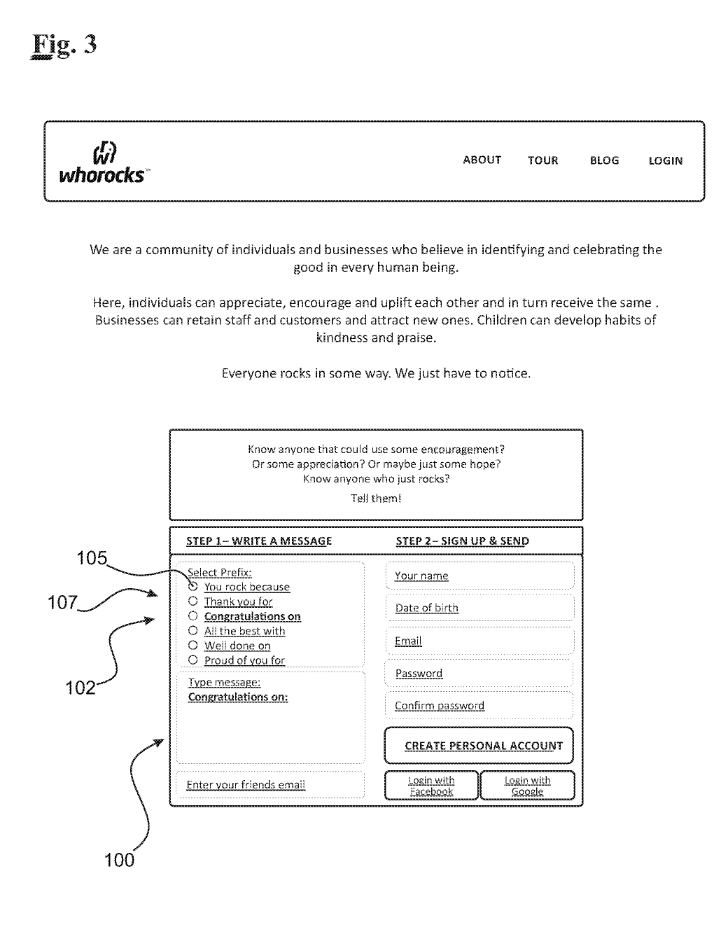

Referring to FIG. 3 a system user 16 is able to send a positive message 100 to a user 16 or an external party 37. The message 100 is preferably analysed using sentiment checking facility that attempts to send only a positive messages 14. In order to encourage registration, the user is able to construct the message 100 before creating a personal account. The user 16 is not able to send the message 100 before having logged in.

The forms facility 20 generates a form 102 providing for the selection of an introductory set of words 105 from a group of available introductory set of words 107. The introductory set of words 107 encourage the provision of a positive message 100. The introductory set of words 107 encourages both positive affirmations and appreciation notes.

In this manner the forms facility 20 provides the ability for a user 16 to select an introductory set of words 107 that begin a positive message 14. The introductory set of words 107 provides an introduction to a positive affirmation or appreciation note.

The introductory set of words 107 includes: ‘You rock because’, ‘Thank you for’, ‘Congratulations on’, ‘All the best with’, ‘Well done on’ and ‘Proud of you for’.

The system 10 includes a profanity check as part of the sentiment checking facility to assist with limiting the probability of a negative message 18 being sent. Email verification and complaint ticket registration facilities can employed to assist with limiting continuing negative and spam messages by offending parties.

After a message is created by a system user 16 and has passed the sentiment checker, the message facility 16 sends an email notification to the addressee of the message advising that a message is waiting.

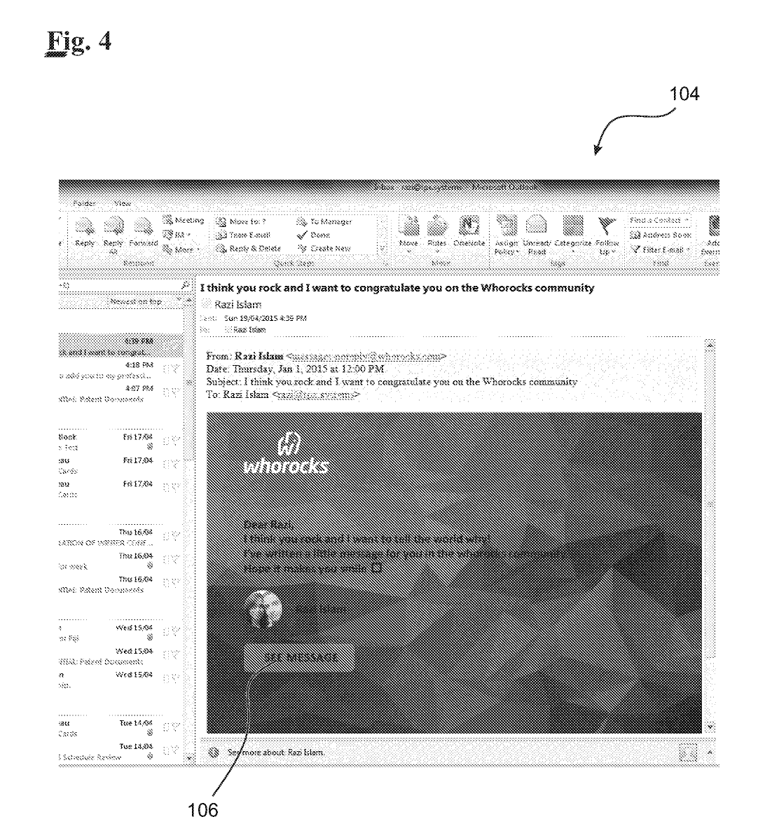

An exemplary notification 104 is illustrated in FIG. 4. The notification 104 encourages the addressee to access the waiting positive message 14 via the social communications system 10. In the embodiment, the message addressee must click the link 106 and register on the system 10 in order to view the message 104.

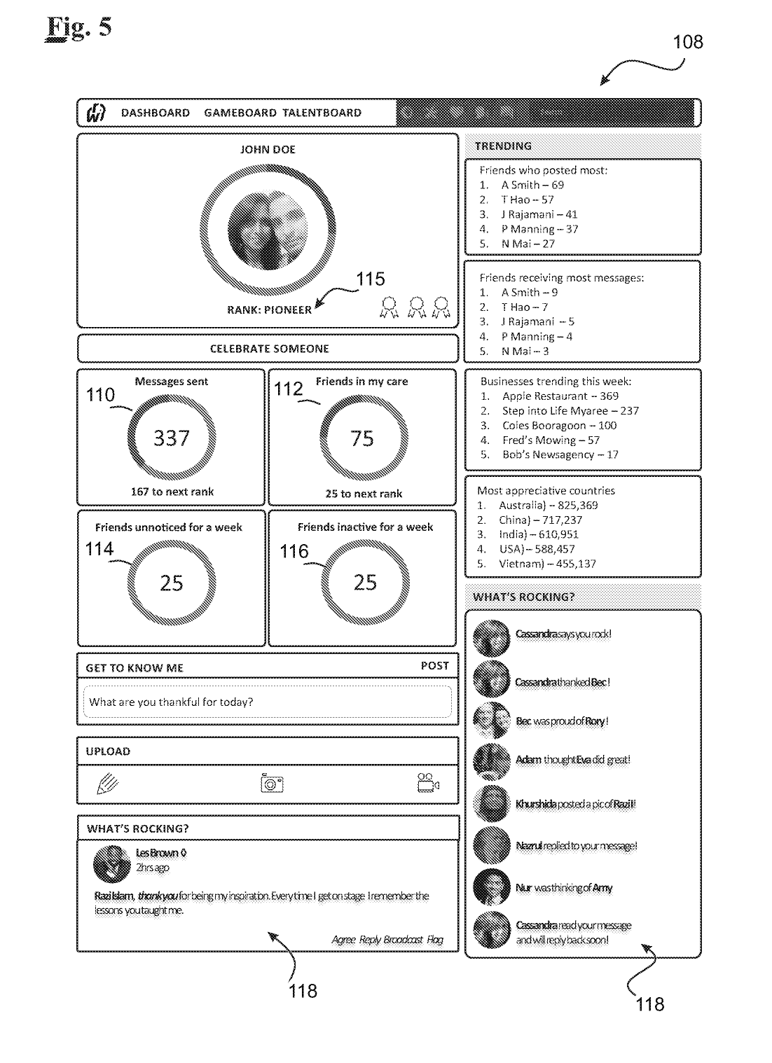

Referring to FIG. 5 a user dashboard 108 is shown. The user dashboard 108 shows various data provided the system 10.

The user dashboard 108 provides a messages sent indicator 110. The messages sent indication 110 indicates how active the user 16 has been since registration. Various customizations are of course possible. For example, the message sent indicator 110 may show the number of weekly messages.

The user dashboard 108 provides a friends indicator 112. The friends indicator 112 indicates how many friends the user 16 has in the user's friends network. The number is calculated by the calculation facility 22.

The user dashboard 108 provides an unnoticed friends indicator 114. The unnoticed friends indicator 114 indicates how many of the user's 16 friends have been unnoticed for a week. The number is calculated by the calculation facility 22.

The user dashboard 108 provides an inactive friends indicator 116. The inactive friends indicator 116 allows the user 16 to monitor how many friends have been inactive for a week. The number is calculated by the calculation facility 22. This advantageously allows the user 16 to notice inactive friends. This may in turn operate to persuade the inactive friend to become active.

A rank indicator 115 provides an overall ranking. The ranking is calculated by the calculation facility 22.

A positive message section 118 provides a positive information area 118 that shows the user 16 various positive messages 14 sent to the user 16 from other users 16. The provision of a number of positive messages 14 from users 16 is considered to provide a motivation for the user 16 to send affirmations and thank you notes to other users 16 and external parties 37.

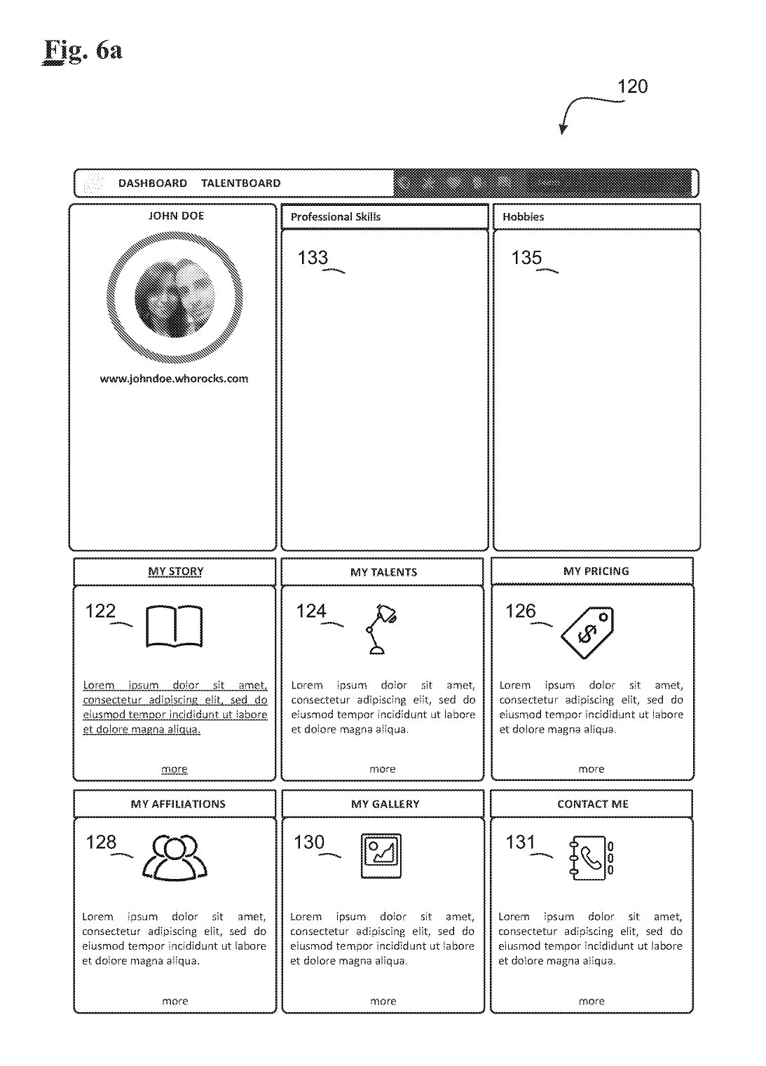

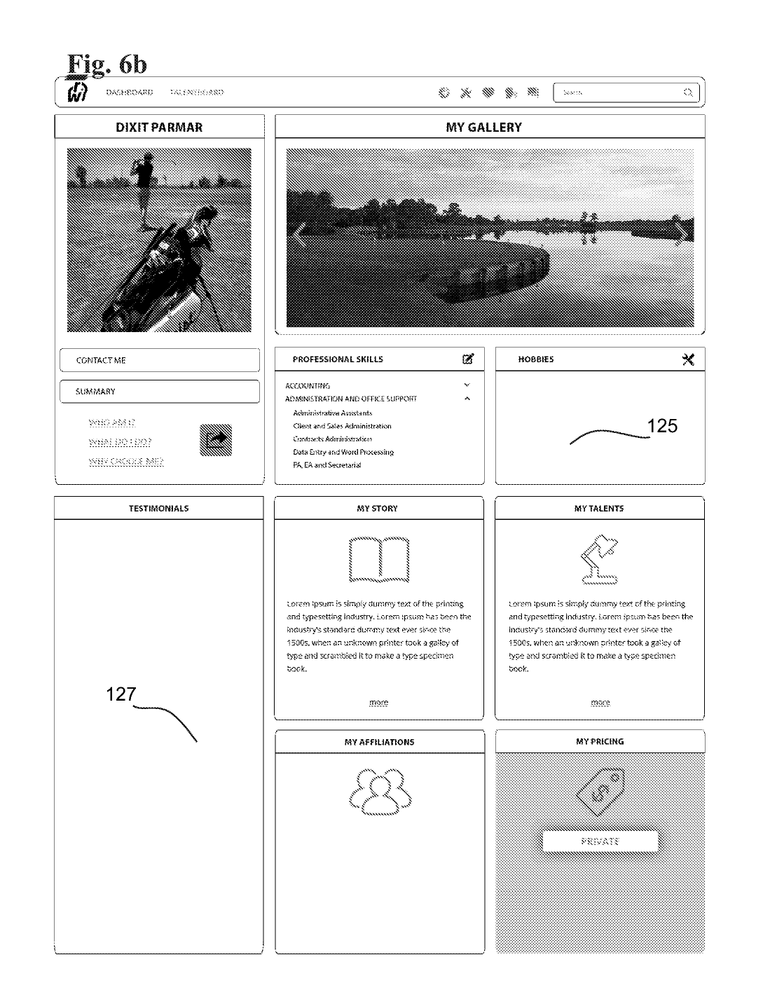

Referring to FIG. 6a there is shown a user profile interface 120. The user profile interface 120 includes a my story section 122, a my talents section 124, a my pricing section 126, a my affiliations section 128, a my gallery section 130 and a contact me section 131. A professional skills section 133 is provided to allow professional skills to be listed. A hobbies section 135 is also provided. FIG. 6b shows an improved user profile interface having a hobbies section 125 and a testimonials section 127.

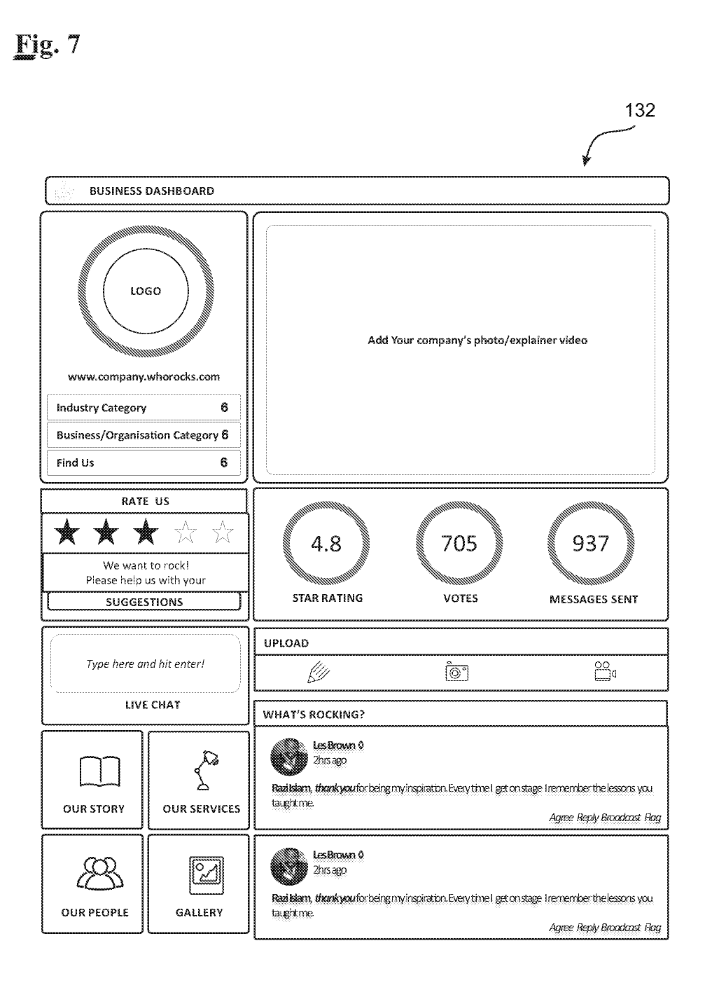

Referring to FIG. 7 there is shown a dashboard 132 for a business account. A business account functions in a similar manner to a personal account in that positive messages 14 are able to be sent to other users 16 and external parties 37. This includes clients are encourage to register with the system 10 in order to read the message and are then encouraged to send positive messages 14.

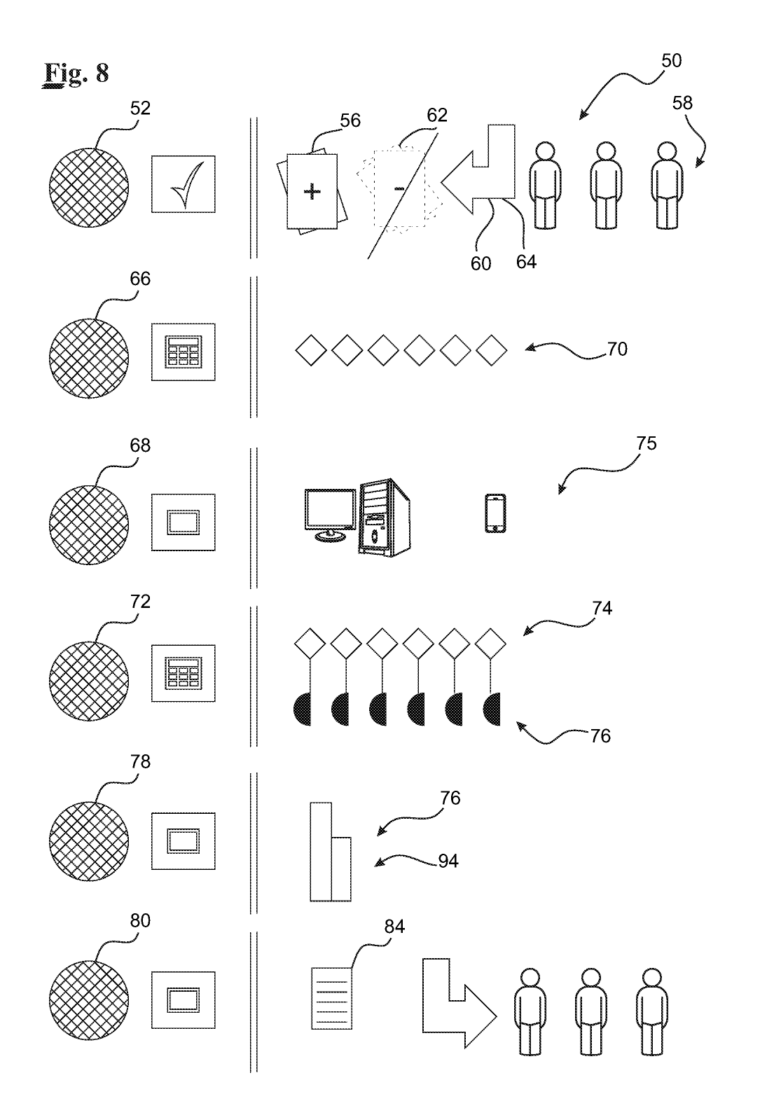

Referring to FIG. 8 there is illustrated a computer implemented social communications method 50 according to another preferred embodiment of the present invention. At block 52 the method 50 includes encouraging the creation and transmission of positive messages 56 from a number of users 58 to provide positive affirmation or appreciation messages 56 from the users 58. The messages 56 are created using a computer implemented message facility 60.

At block 52, the method 50 includes limiting the creation and transmission of negative messages 62 from the users 58 using the message facility 60, where the negative messages 62 would operate to denigrate the users 58 or external parties (not shown). Spam messages are also limited. As part of the method 50 a forms facility 64 is used to assist the users 58 with the construction of the positive messages 56.

At block 66 the method includes calculating scores 70 relating to the positive messages 56 sent by the users 58 using the message facility 60. At block 68 the method 50 includes displaying the scores 70 relating to the positive messages 56. The scores 70 are accessed by the user using a computer terminal 75.

At block 72 the method 50 includes calculating scores 74 relating to the number of unnoticed associated users 76 in connection with each user 58. The unnoticed associated users 76 of each user 58 are unnoticed during a period of a set number of weeks, due to no positive messages 56 being sent by the user 58 to each unnoticed associated user 76.

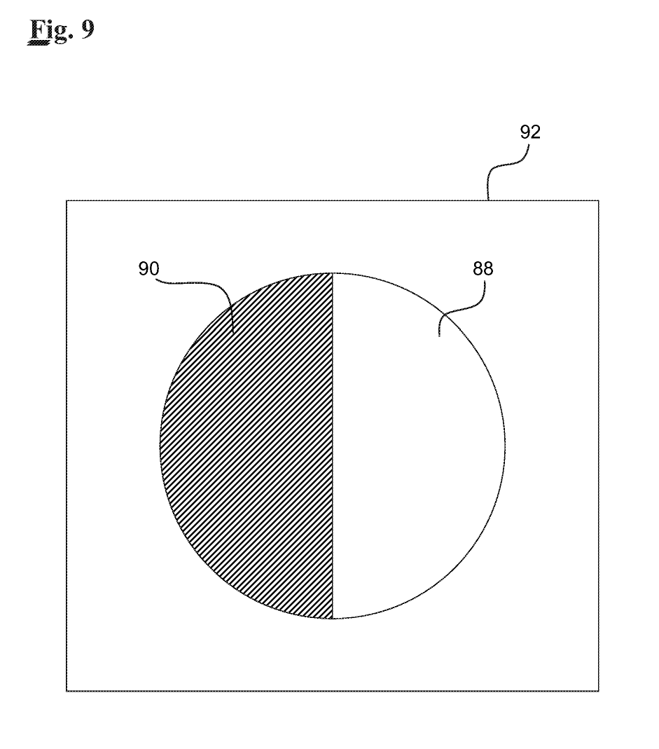

Referring to FIG. 9 each user 58 has a number of noticed associated users 88 and a number of unnoticed associated users 90 in an associated user network 92. The users who associated are created in the method by sending connection requests that are accepted. The term associated user embraces such things as ‘electronic friends’ and ‘connected users’ who have accepted requests.

At block 78 the method 50 includes displaying the number of unnoticed associated users 76 of each user 58 in a graphical interface 94. At block 80 the method 50 includes proactively sending the users 58 one or more messages 84 seeking the creation of positive messages 56 from the users 58 (to other users 58 and external parties (not shown)).

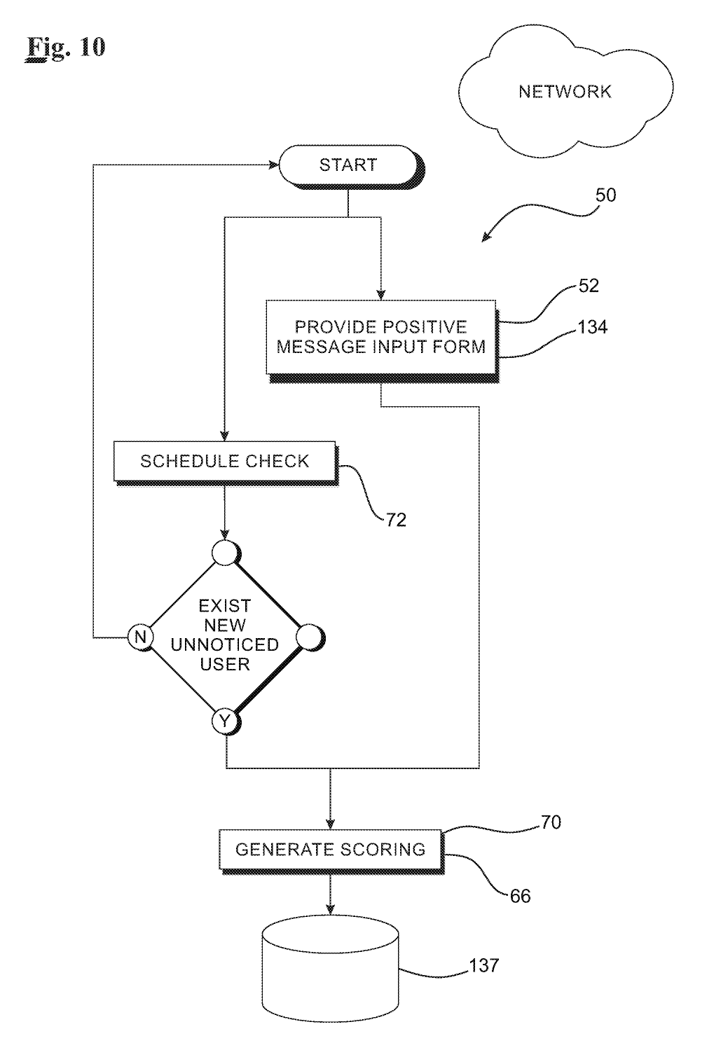

Referring to FIG. 10, the method 50 provides a positive message input form 134 at block 52 as part of a graphical user interface. If a message is sent a database 137 is updated to reflect the updated scoring 70 at block 66. At block 72, the method 50 includes scheduling checks to determine whether a user 58 should change from being noticed to being unnoticed and whether the scoring should be updated.

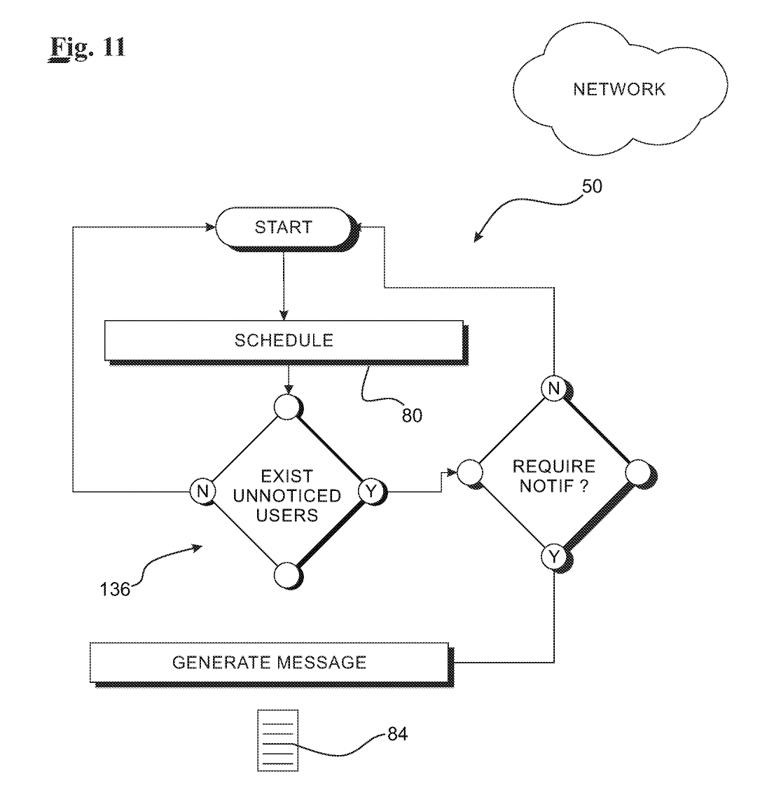

Referring to FIG. 11, the method 50 is configured to proactively send messages 84 at block N. This is achieved by checking whether a user 58 requires a reminder to notice an unnoticed user at block 136.

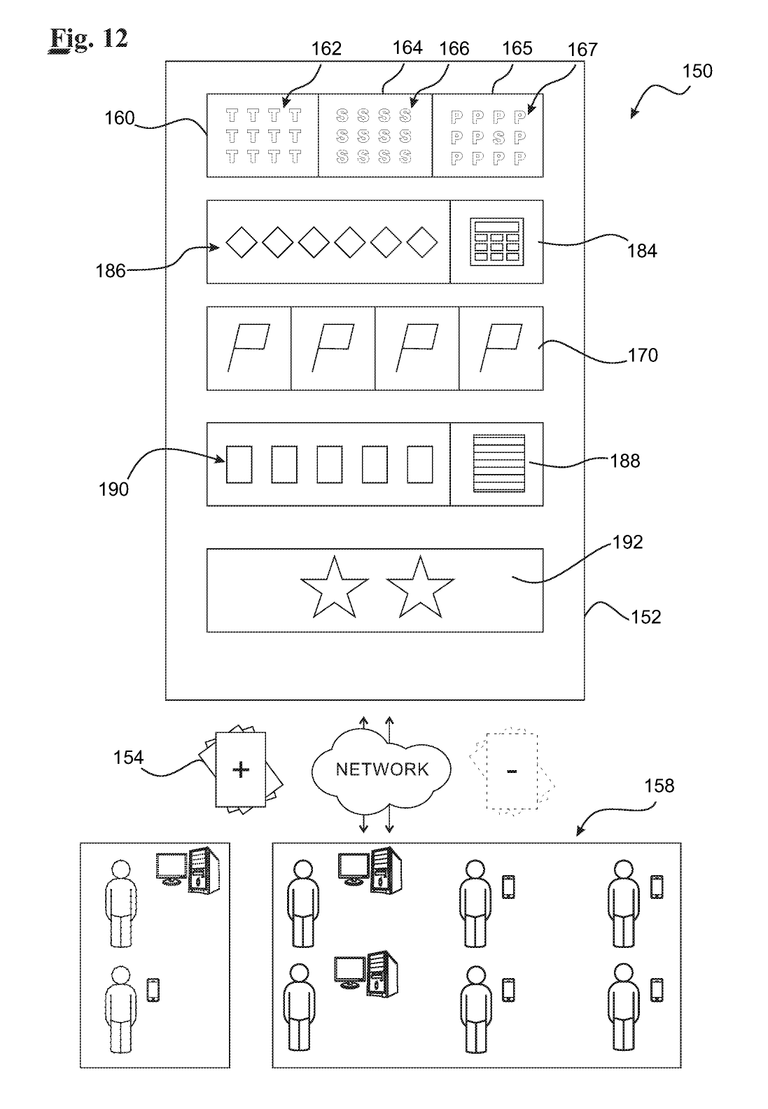

Referring to FIG. 12 there is shown a computer implemented social communications system 150. Similarly to the previous embodiments there is provided a message facility 152 that is configured to encourage the creation of positive messages 154 that provide affirmation or appreciation messages 156 from system users 158. The message facility 152 is configured to limit the creation of negative messages from the system users 158 that would denigrate the system users 158 or external parties.

There is advantageously provided a teacher facility 160 for providing system users 158 with teacher accounts 162 and a student facility 164 for providing system users 158 with student accounts 166. There is further provided a parent facility 165 for providing system users 158 with parent accounts 167. In the system the student accounts 166 are associate with particular teacher accounts 162 and with particular parent accounts 167. In the embodiment the system 150 is provided as a teacher-student social communications system 150 that is hosted at a pre-primary school.

The system 150 is considered to be particularly advantageous for use in pre-primary and primary schools but may also find application in other types of school. The message facility 152 includes a forms facility (not shown) for assisting the system users 158, with the construction of the positive messages 154.

A flag facility 170 is provided for allowing a teacher account 162 to flag an inappropriate message created by a student account 166 that is associated with the teacher account 162 and to share the flag with another teacher account 162 that is associated with the student account 166. In this manner a teacher is able to flag and inappropriate message of the teacher's student with another teacher of the student. As a result, inappropriate messages are able to be shared between classrooms so that teachers are better informed and therefore able to address student issues.

In addition the flag facility 170 allows the teacher 172 to flag an inappropriate message created by user of a student account 166 to share the flag with a parent account 167 that is associated with the student account 166. The provisions of parent accounts 167 in the system 150 assists with teacher-parent communications. The flag facility 170 allows teachers to share both appropriate and inappropriate messages sent by students with their parents. The messages are flagged using the flag facility 170 by being shared with the parent account associated with the student.

The system 150 includes a calculation facility 184 for calculating scores 186 relating to the positive messages 154 sent by the system users 158 using the message facility 152. The scores are able to be shared with students to encourage the creation of positive messages.

The calculation facility 184 is provided for calculating scores 186 relating to the positive messages 154 sent by the system users 158 using the message facility 152. The user of a student account 166 is able to advantageously use the message facility 152 to select whether to create positive messages for a teacher account 162 or a student account 166. In this manner a student is able to communicate appreciation for both other students and the teachers of the student. This is considered to be particularly useful and should allow the identification of particular types of student by the teacher

The calculation facility 184 is advantageously configured to calculate a different score based on a positive messages being created by a user of a student account 166 being for a teacher account 162 or for another student account 166.

Advantageously, parents having parent accounts 167 in the system are able to view the scores of their children along with aggregated scores of other children (to provide a benchmark). In this manner parents are able to judge their students' progress as to this aspect of the learning environment.

The calculation facility 186 is able to advantageously calculate scores relating to the positive messages sent by the system users 158 using the message facility 152 and a user 158 of a teacher account 162 is provided with the ability to award additional points for exceptional affirmation messages.

The system 150 further includes a notes facility 188 that allows the user of a teacher account 162 to store one or more comments 190 in connection with a message created by the user of a student account 166. The system 150 further includes a merit facility 192 allowing the user of a teacher account 162 to award points for exceptional affirmation messages and to share those affirmation messages with parents having parent accounts.

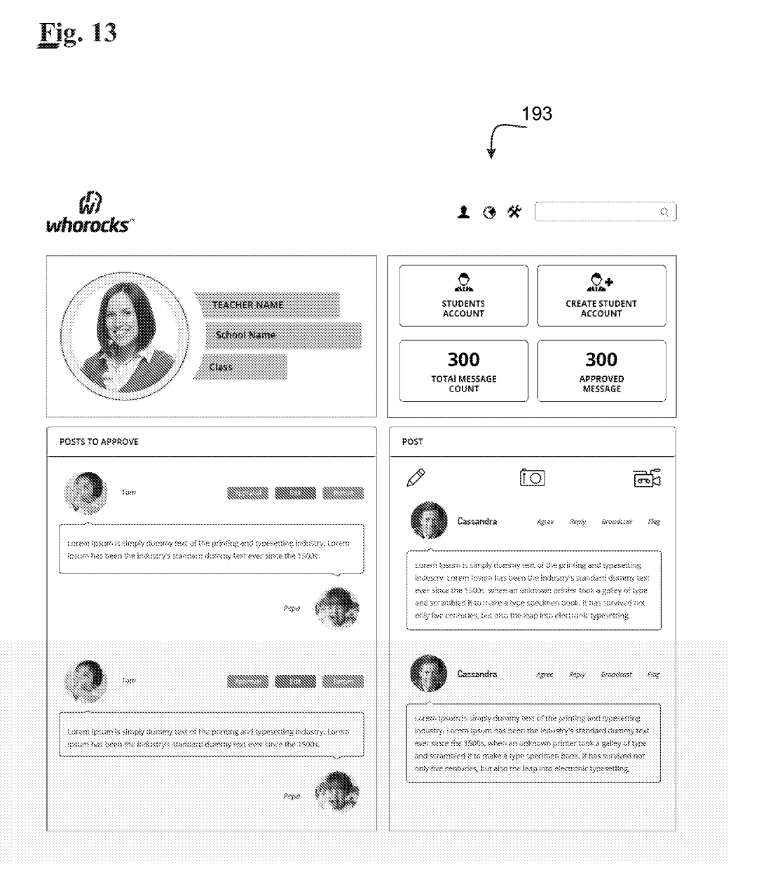

FIG. 13 illustrates one teacher account user interface 193. The teacher associated with the teacher account is able to monitor and approve messages sent by students. The teacher account user interface 192 allows the teacher to approve, edit or return student messages. When returning a message, the teacher is able to add a comment for review by the student. The teacher account user interface 192 allows the teacher to post messages to other teachers having teacher accounts 162.

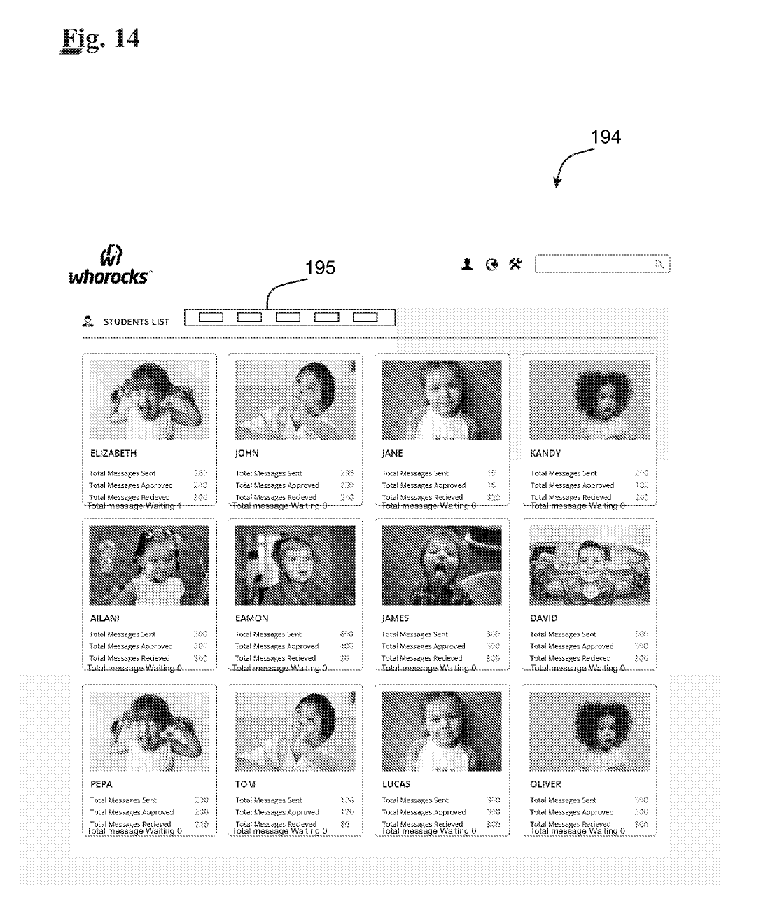

FIG. 14 illustrates a student list user interface 194 that is able to be displayed as part of a teacher account 162. The student data is able to be sorted in ascending or descending order based on messages sent, received or awaiting approval to assist the teacher to detect any signs of isolation or social development issues.

A sort facility of the system provides buttons 195 to allow the student data to be sorted in ascending or descending order based on messages sent, received or awaiting approval to assist the teacher to detect any signs of isolation or social development issues. Total messages awaiting approval should be included in the message list shown in FIG. 14 for each student.

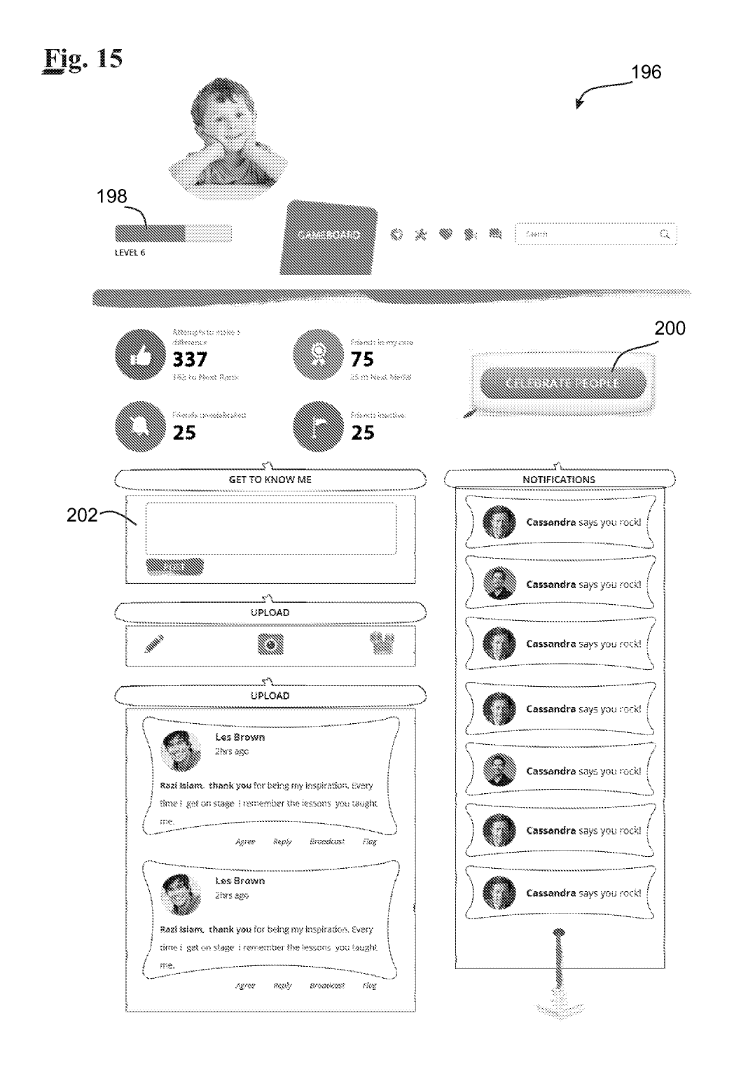

FIG. 15 illustrates a student account interface 196. The calculation facility 184 provides a level score 198 based on the student's performance in the student account interface 196. Positive messages are able to be sent using a celebration button 200. In addition to the celebration aspects, general posts can be made in the post area 202. The post area 202 allows general posts for the user to post something on their own page. These messages are also monitored by the teacher and do not receive points that increase a student level score 198.

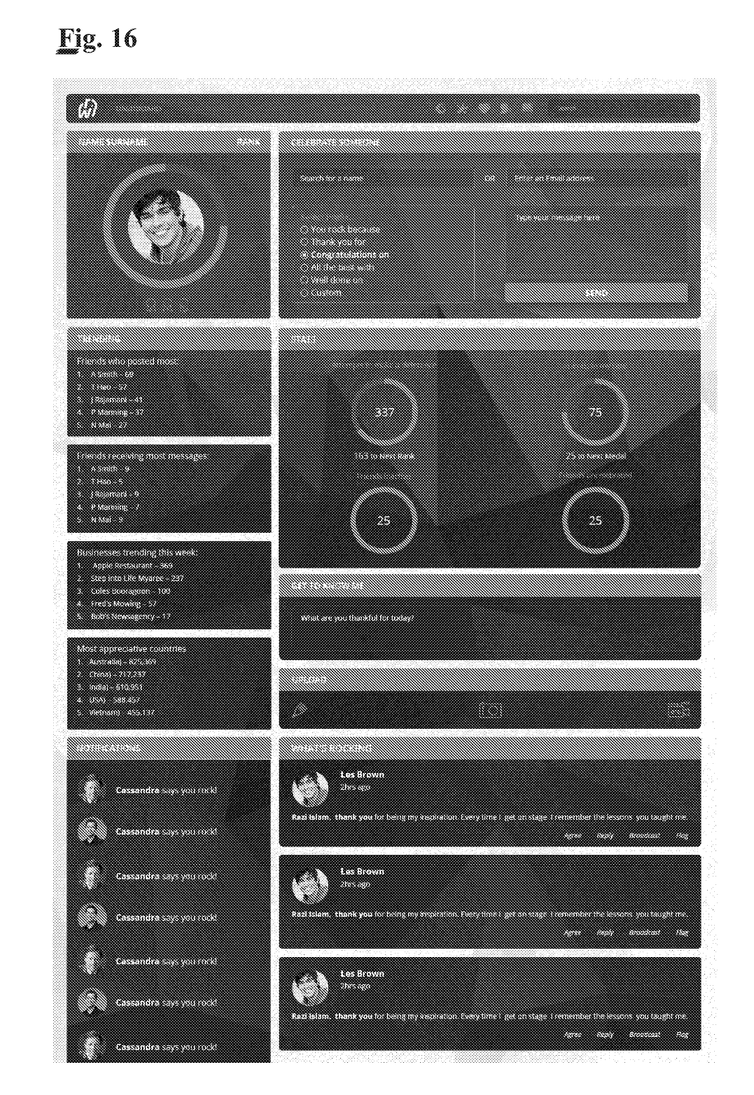

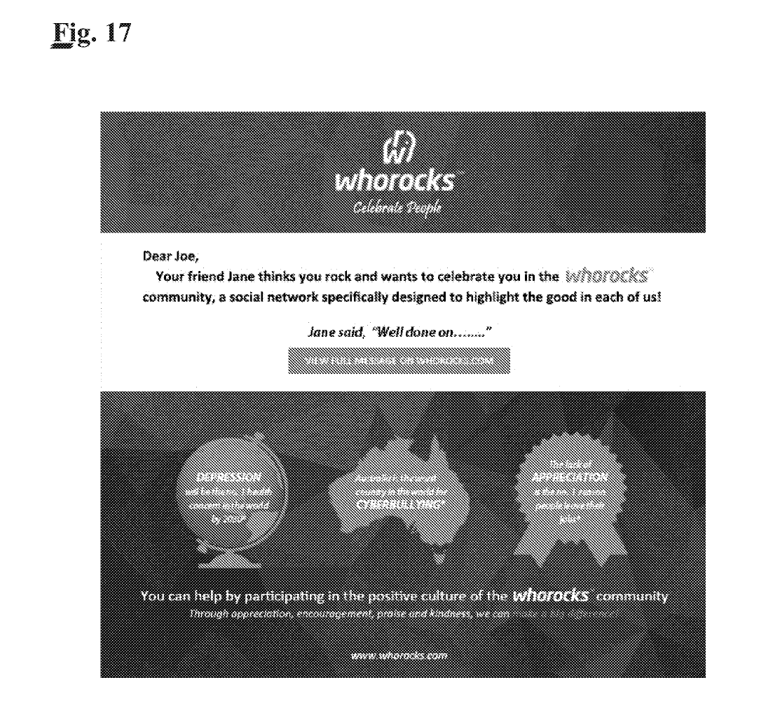

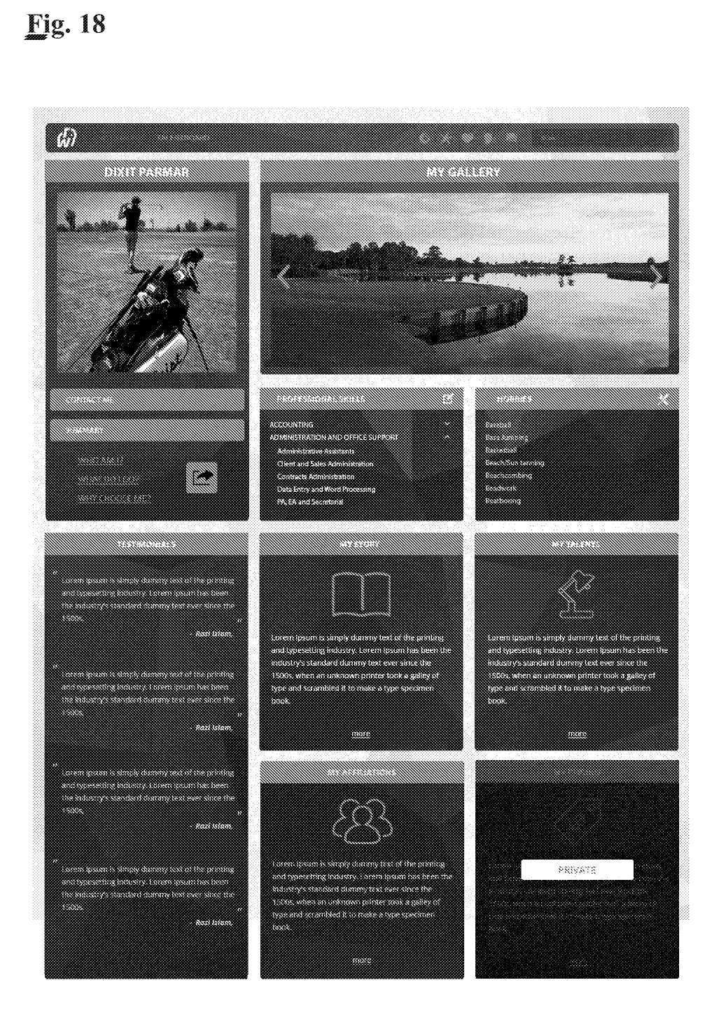

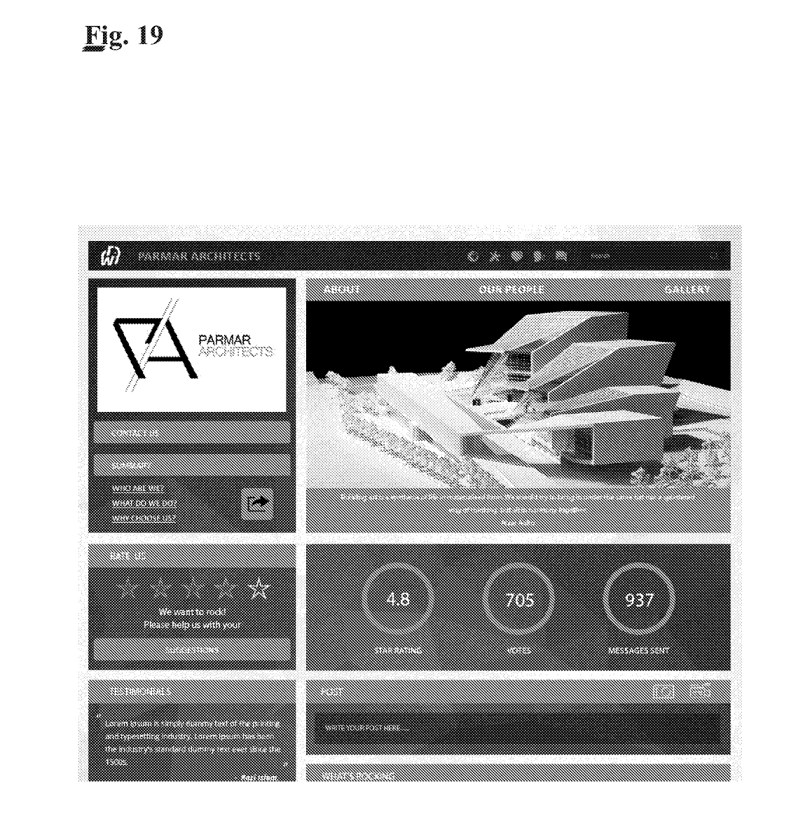

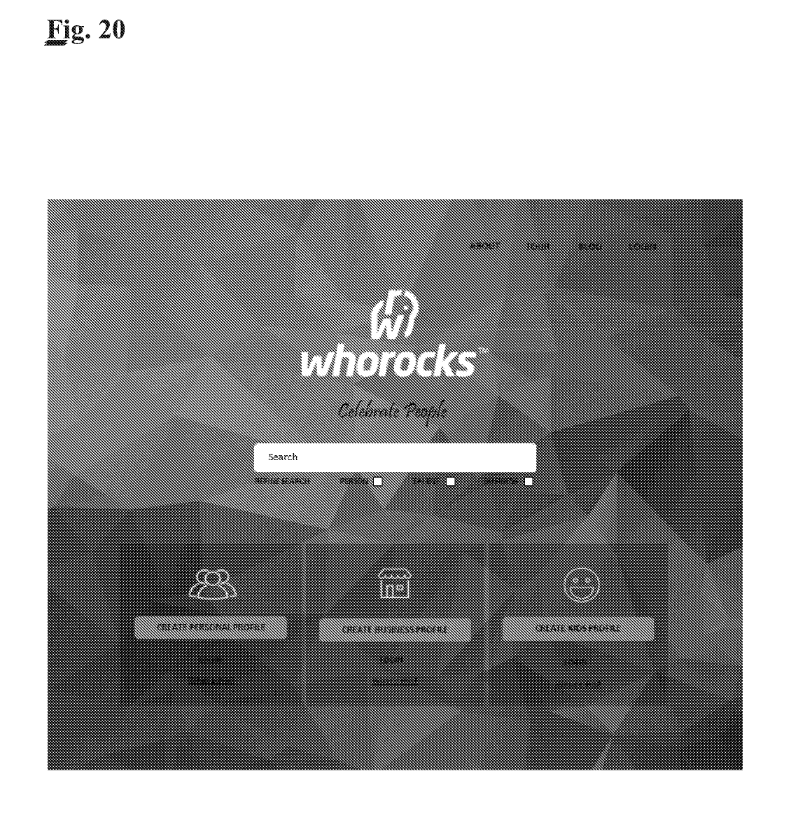

FIGS. 16 to 20 illustrate a number of graphical user interfaces according various preferred embodiments of the present invention.

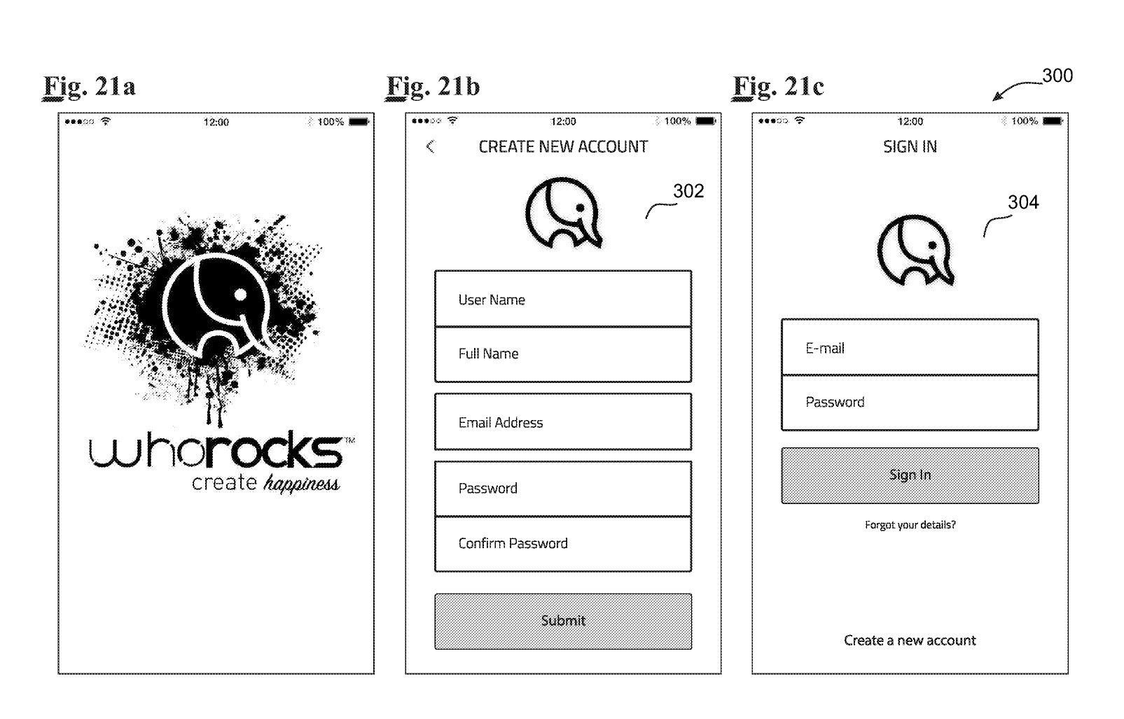

FIGS. 21a to 29b illustrate a further preferred embodiment of the present invention. The embodiment comprises a communications system 300 involving the same general structure and functionality of the communications system 10. The communications system 300 is described in the context of a mobile application of similar functionality.

One further advantageous feature of the mobile application comprises the provision of a selector allowing a user to select an image to form part of a positive affirmation or appreciation message. This is considered to provide an advantageous feature improving the communications systems and methods previously described. As before the social communications system 300 is provided for number of system users.

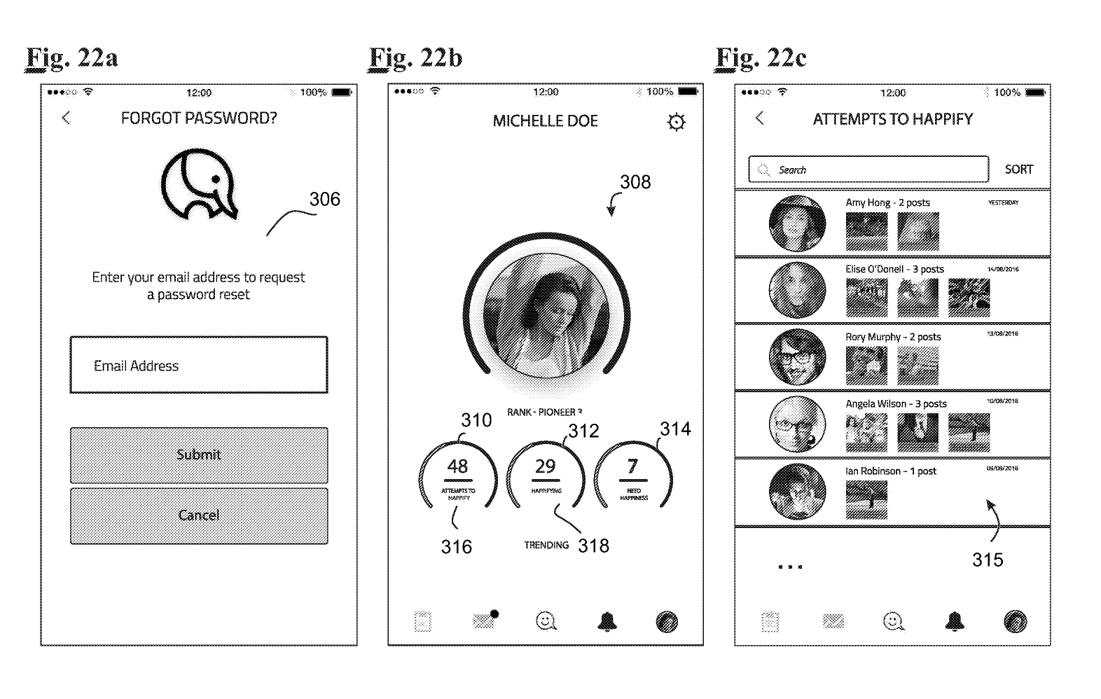

Referring to FIGS. 21a to 22a, a user creates a new account using an interface 302. The user is then able to sign in to the system using an interface 304. If the user has forgotten a password, the password can be recovered using an interface 306.

Referring to FIG. 22b, once signed in, the system user is presented with a dashboard 308. The dashboard 308 provided by the system 300 includes an outgoing messages indicator 310, a total friends indicator 312 and an unnoticed friends indicator 314. The outgoing messages indicator 310 shows the actual number of positive messages sent to the system user's friends. The total friends indicator 312 shows the number of associated system users of the system user. The unnoticed friend's indicator 302 shows how many friends of the system user have been unnoticed by the system user.

In another embodiment an indicator is provided showing the number of associated users to whom messages have been sent by the system user. In yet another embodiment an indicator is provided showing the number of positive messages received by the system user.

Referring to FIG. 22b, the ability to show how many friends of a system user have been unnoticed allows for action to be taken. With the system user being presented with the information, the system user can view a list of unnoticed friends and send positive messages.

The communication system 300 communicates with a calculation facility. As before, the calculation facility is provided for calculating scores relating to the number of unnoticed associated users that are associated with each system user. More particularly, in the embodiment, each unnoticed associated user, associated with each system user, is unnoticed by the system user for a predetermined period due to no positive messages being sent by the system user. Associated users of a system user constitute ‘friends’ of the system user, the associated users having accepted a ‘friend’ request.

Referring to FIGS. 22b and 22c, by activating an activator 316 the system shows users 315 associated with the system user who have received positive affirmation or appreciation messages from the system user. The indicator 310 shows the total number of messages sent by the system user.

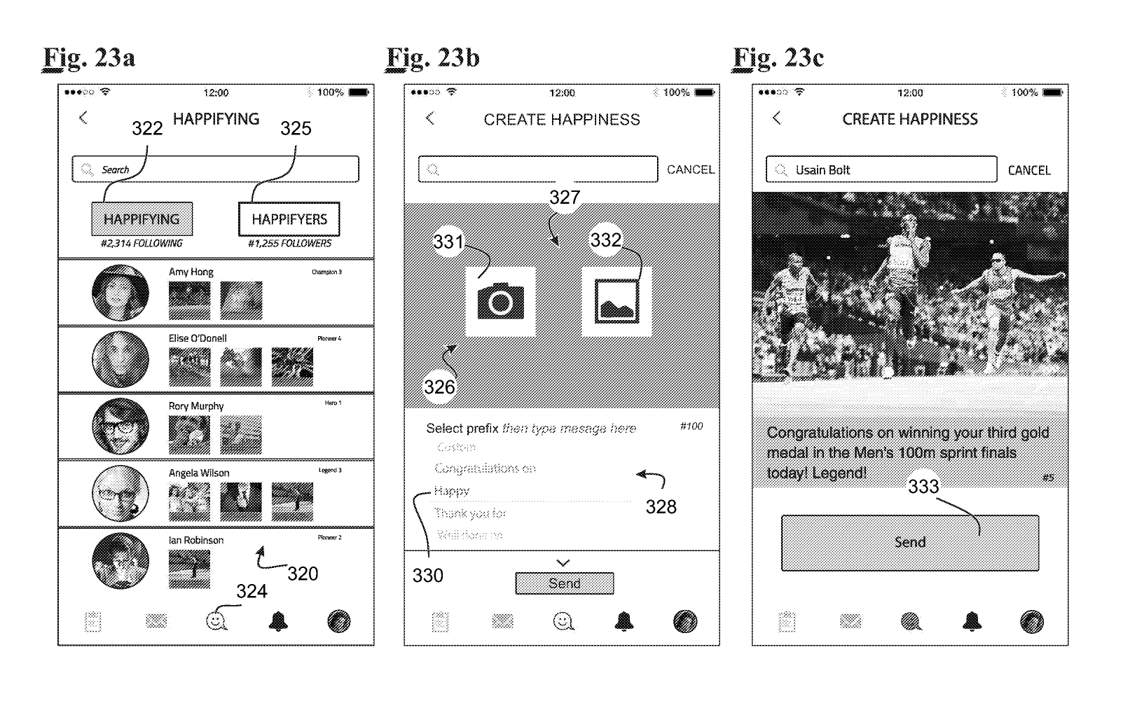

Referring to FIGS. 22b and 23a, by activating an activator 318 this illustrates system users 320 associated with the system user. These users have accepted friend requests from the system user and are displayed in a list. These system users are friends ‘followed’ by the system user. The system user is in effect subscribed to the followed users. This is indicated by an activator 322.

By activating an activator 325 a list (not shown) is presented of users where the system user has accepted friend requests sent by the users. These system users are friends ‘following’ the system user. The users are in effect subscribed to the system user.

As before, unnoticed associated users of each system user are defined as being unnoticed for a predetermined period of time, due to no positive messages being sent by the system user to the unnoticed associated users. As would be apparent various definitions of an unnoticed user are possible in different embodiments.

Referring to FIG. 23a, by activating a new outgoing message button 324, it is possible to show a selector 326. The selector 326 advantageously provides the ability for a system user to select an image to form part of a new positive message.

This is performed by activating an activator 327 and specifying a custom image or selecting one of a number of predetermined images. The selection of a custom image returns a forms facility 328 encouraging the provision of positive messages by providing for the selection of an introductory set of words 330 based on the selection of a custom image.

The activator 327 provides a first button 331 that uses the mobile phone's photo gallery to take a picture or a video, or to select a picture or video from the camera's gallery. A second button 332 allows the selection of an image or video from a database of predetermined images or videos.

When one of a number of predetermined images/videos are selected the forms facility 312 is configured to tailor the affirmation or appreciation messages (that is select the introductory set of words) based on data associated with a selected predetermined image. In this embodiment this is achieved by associating each predetermined image with particular introductory sets of words. The prefix is completed to provide a message (including the image/video) and is sent using a send button 333 as shown in FIG. 23c.

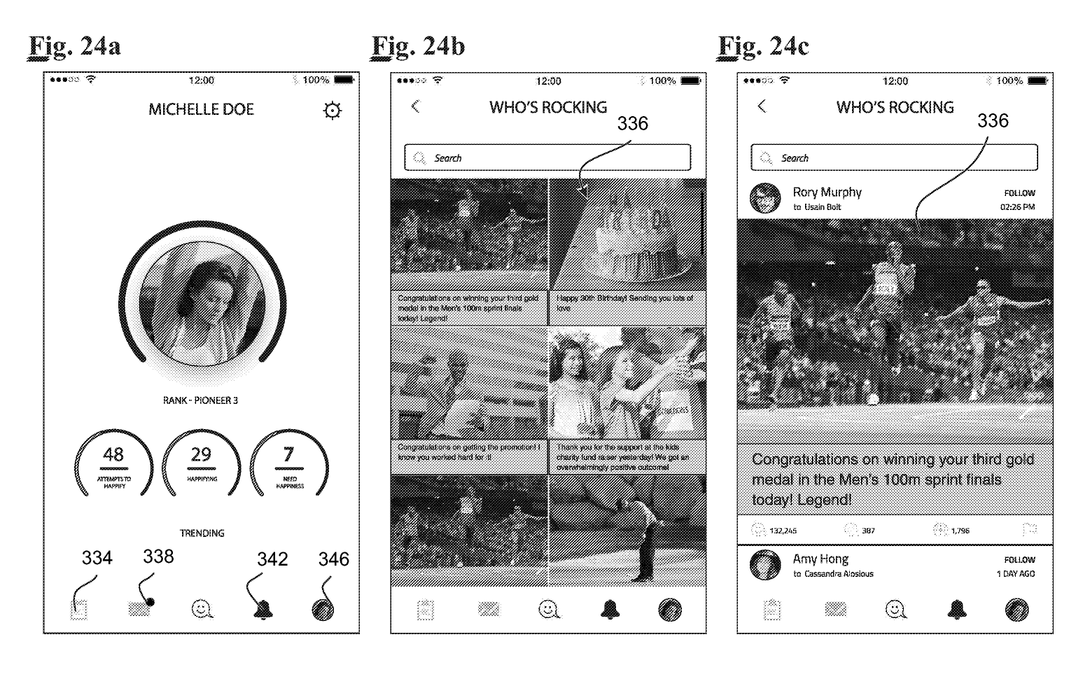

Referring to FIGS. 24a to 24c, by clicking on a newsfeed button 334 it is possible to view and search for all outgoing positive messages 336 between associated followers of the user and the users the user is following. In the embodiment the global newsfeed shows messages that have been sent by the user's followers and the users the user is following.

This is not necessarily in chronological order, for example in FIG. 24c, the user may know Rory Murphy, but may not know Usain Bolt (or vice versa). The user now has the ability to follow/happify whoever the user didn't know. FIGS. 24b and 24c allow users to know all the positive things that people are saying about each other around them.

It is considered that messages create the positivity spark. What is seen in FIG. 24b is considered to encourage the growth of positivity as the user sees more and more people acting in a positive way.

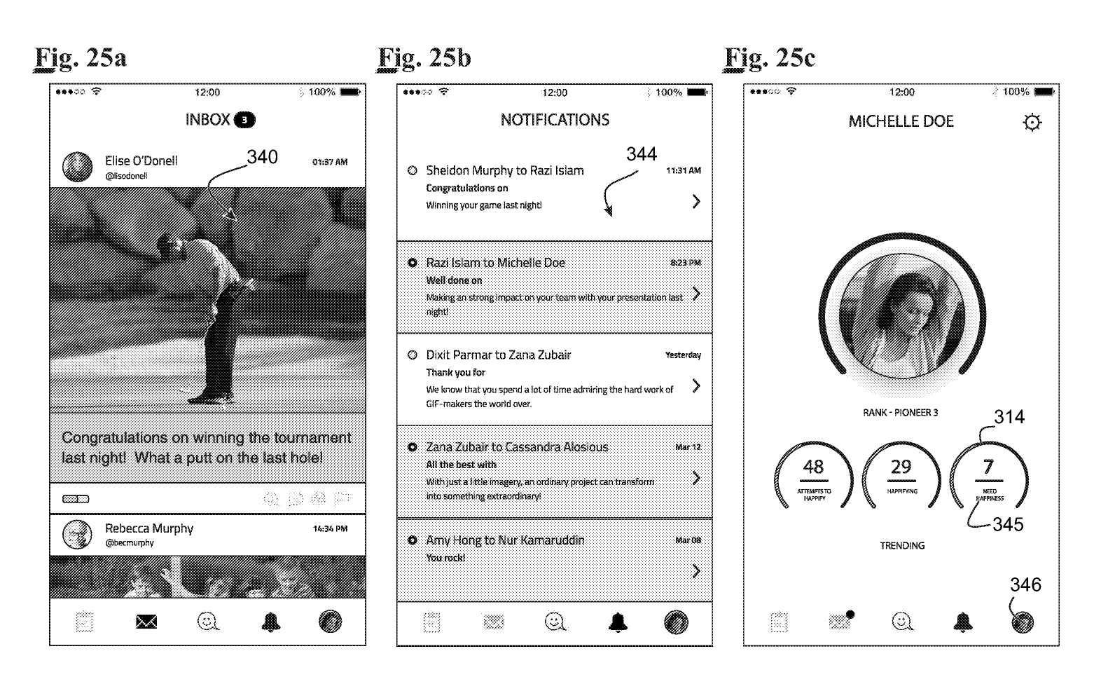

Referring to FIGS. 24a and 25a, by clicking on a new message button 338 it is possible to view and search for all incoming positive messages 340. The messages 340 are provided in a scrollable list.

Referring to FIGS. 24a and 25b, by clicking on a notifications button 342 it is possible to view all incoming positive messages 344 and updates on the activities of associated users.

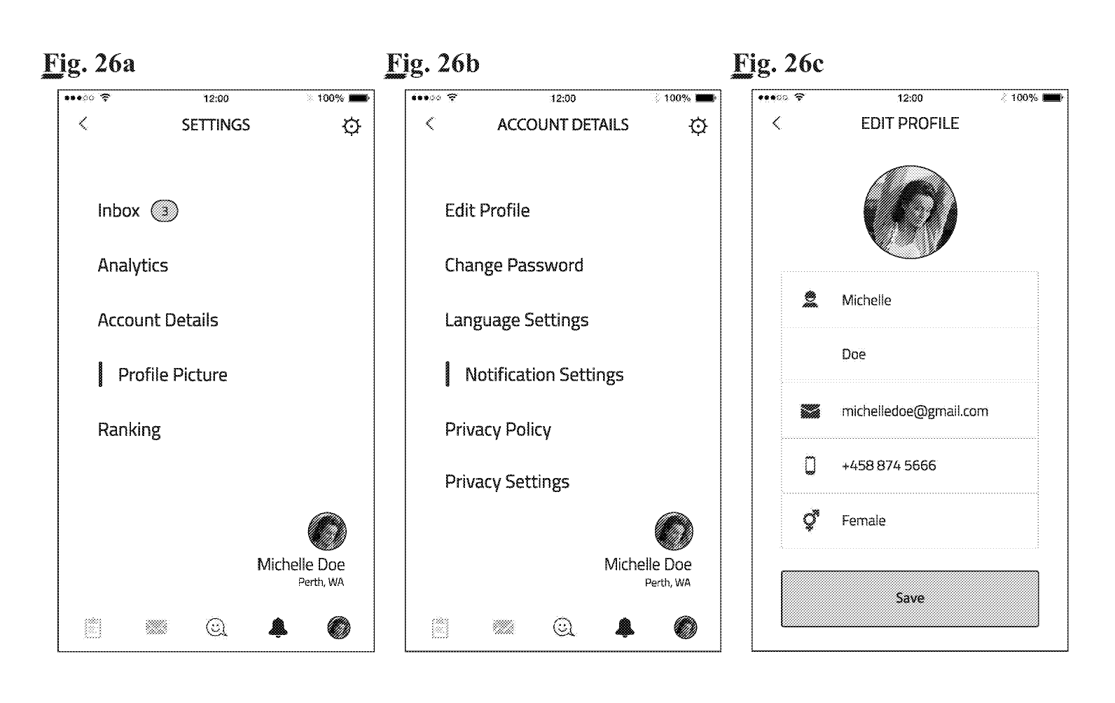

Referring to FIGS. 25a and 26a to 26c, by clicking on a profile button 346 it is possible to edit profile information.

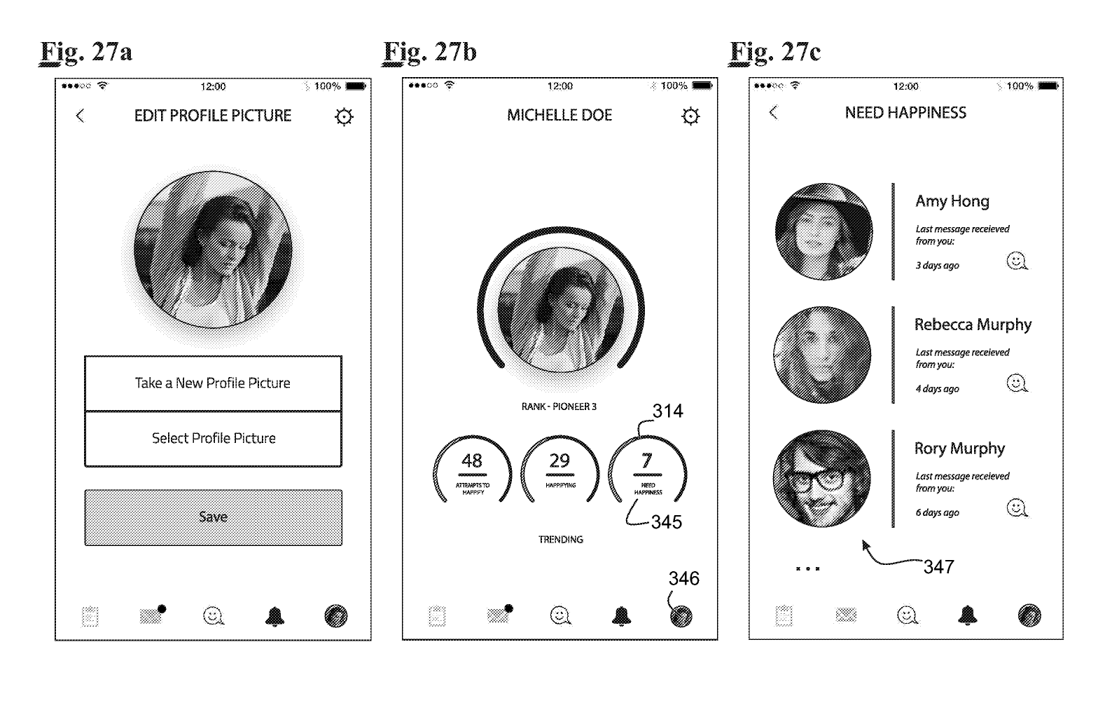

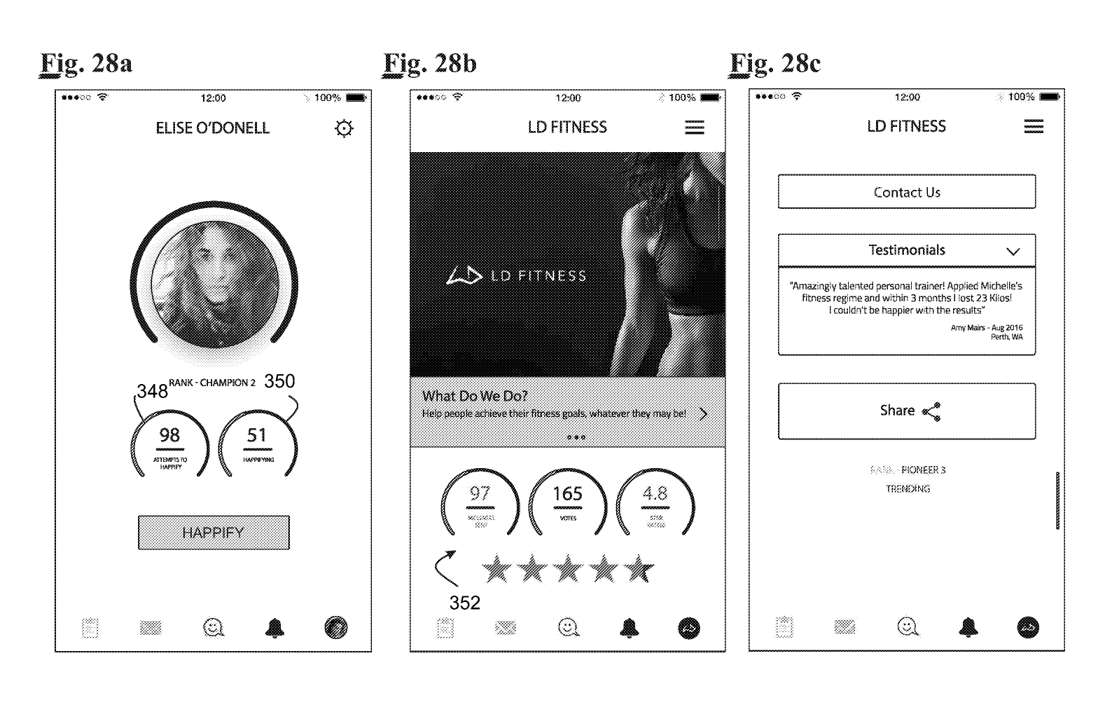

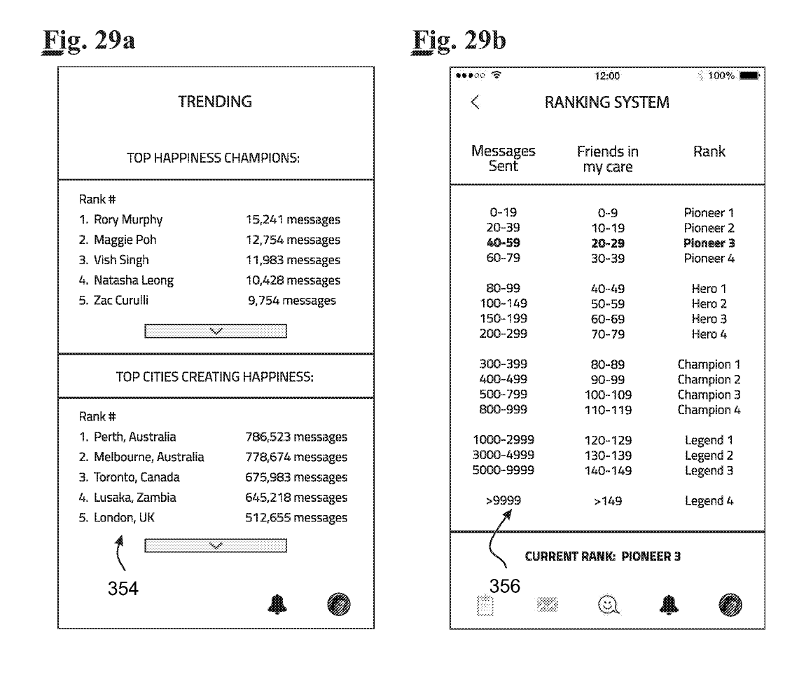

Referring to FIGS. 27b to 28a, by clicking on an unnoticed friends activator 345 it is possible to view unnoticed friends 347. Clicking on a friend 347 shows the number of attempts 348 to happify the unnoticed friend by all the unnoticed friend's friends. An indicator is also provided showing the number 350 of friends of the unnoticed friend. Referring to FIGS. 28b and 28c, friends may also comprise businesses 352 where a star rating is applied. Referring to FIG. 29a, a ranking system 354 is applied. Referring to FIG. 29b, trending users 356 are shown.

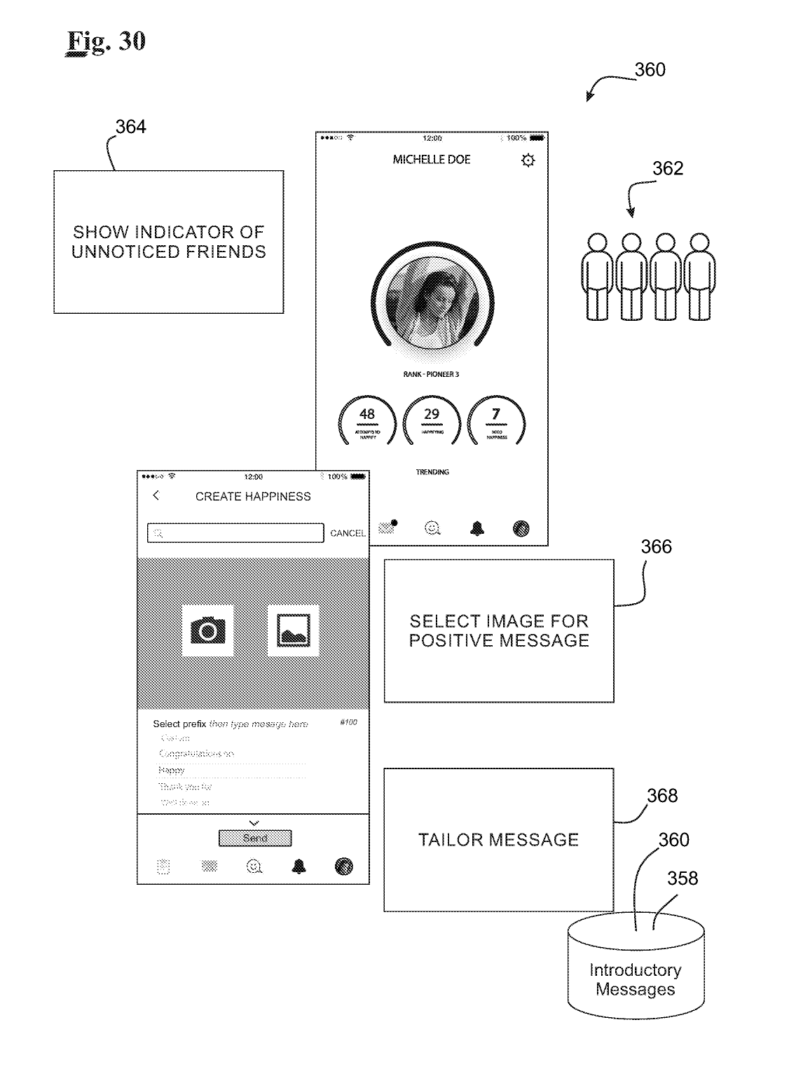

The manner of operation is illustrated with reference to FIG. 30 in relation to a computer implemented social communications method 360 according to a further preferred embodiment of the present invention. The method 360 is provided in connection with a number of system users 362. At a first block 364 the method 350 includes showing, using an indicator, how many friends of a system user have been unnoticed by the system user.

The method 360 communicates with a system calculating scores relating to the number of unnoticed associated users that are associated with each system user. Each unnoticed associated user associated with each system user, is unnoticed by the system user for a predetermined period due to no positive messages being sent by the system user to the unnoticed associated user.

At block 366, the method 360 includes providing the ability for a user to select an image/video to form part of the positive affirmation or appreciation message. At block 368 the method 360 includes tailoring the affirmation or appreciation message based on data 358 associated with a selected image/video. The data 358 is stored on a data store 360.

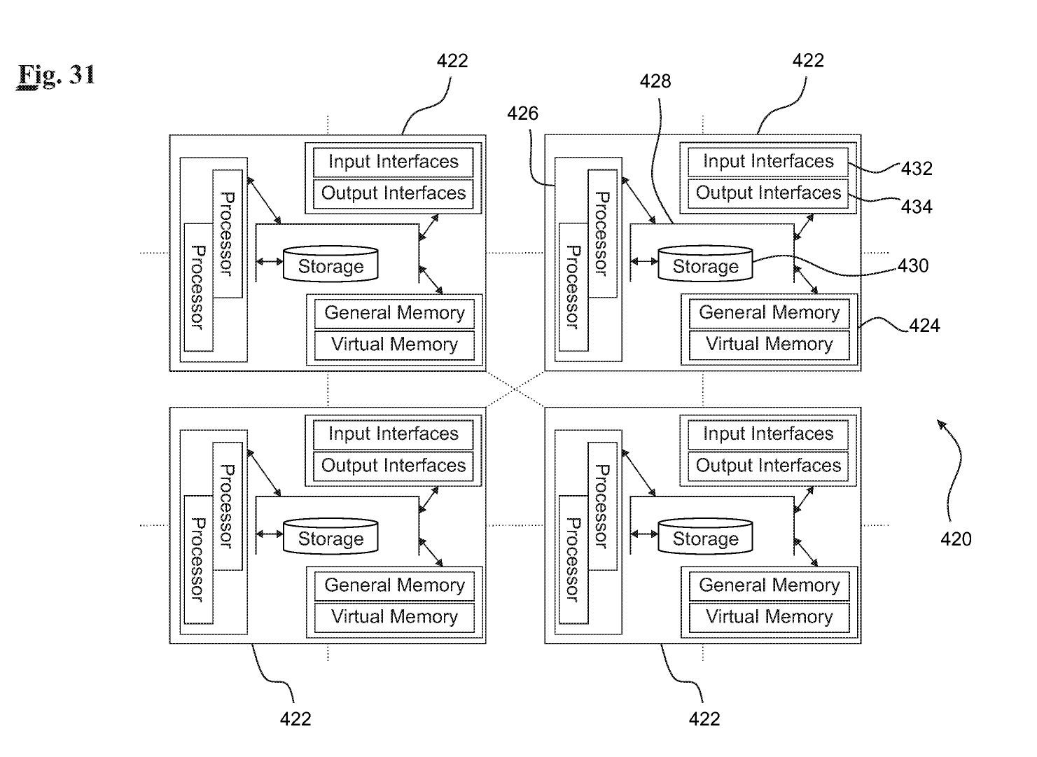

Referring to FIG. 31 there is shown a schematic diagram of a computer system 420 that is configured to provide preferred arrangements of systems and methods described herein. The computer system 420 is provided as a distributed computer environment containing a number of individual computer systems 422 (computers/computing devices) that cooperate to provide the preferred arrangements. In other embodiments the computer system 420 is provided as a single computing device.

As shown, a first one of the computing devices 422 includes a memory facility 424. The memory facility 424 includes both ‘general memory’ and other forms of memory such as virtual memory. The memory facility 424 is operatively connected to a processing facility 426 including at least one processor. The memory facility 424 includes computer information in the form of executable instructions and/or computer data. The memory facility 424 is accessible by the processing facility 426 in implementing the preferred arrangements.

As shown each of the computing devices 422 includes a system bus facility 428, a data store facility 430, an input interface facility 432 and an output interface facility 434. The data store facility 430 includes computer information in form of executable instructions and/or computer data. The data store facility 430 is operatively connected to the processing facility 426. The data store facility 430 is operatively connected to the memory facility 424. The data store facility 430 is accessible by the processing facility 426 in implementing the preferred arrangements.

Computer information may be located across a number of devices and be provided in a number of forms. For example the data store facility 430 may include computer information in the form of executable instructions and/or computer data. The computer data information may be provided in the form of encoded data instructions, data signals, data structures, program logic for server side operation, program logic for client side operation, stored webpages and so forth that are accessible by the processing facility 426.

On one level, input interfaces allow computer data to be received by the computing devices 422. On another level, input interfaces allow computer data to be received from individuals operating one or more computer devices. Output interfaces, on one level, allow for instructions to be sent to computing devices. On another level, output interfaces allow computer data to be sent to individuals. The input and output interface facilities 432, 434 provide input and output interfaces that are operatively associated with the processing facility 426. The input and output facilities 432, 434 allow for communication between the computing devices 422 and individuals.

The computing devices 422 provide a distributed system in which several devices are in communication over network and other interfaces to collectively provide the preferred arrangements. Preferably there is provided at least one client device in the system of computing devices 422 where the system is interconnected by a data network.

The client device may be provided with a client side software product for use in the system which, when used, provides systems and methods where the client device and other computer devices 422 communicate over a public data network. Preferably the software product contains computer information in the form of executable instructions and/or computer data for providing the preferred arrangements.

Input interfaces associated with keyboards, mice, trackballs, touchpad' s, scanners, video cards, audio cards, network cards and the like are known. Output interfaces associated with monitors, printers, speakers, facsimiles, projectors and the like are known. Network interfaces in the form of wired or wireless interfaces for various forms of LANs, WANs and so forth are known. Storage facilities in the form of floppy disks, hard disks, disk cartridges, CD-ROMS, smart card, RAID systems are known. Volatile and non-volatile memory types including RAM, ROM, EEPROM and other data storage types are known. Various transmission facilities such as circuit board material, coaxial cable, fibre optics, wireless facilities and so forth are known.

It is to be appreciated that systems, components, facilities, interfaces and so forth can be provided in several forms. Systems, components, facilities, interfaces and so forth may be provided as hardware, software or a combination thereof. The present invention may be embodied as computer readable memory, a personal computer and distributed computing environments.

In addition the present invention may be embodied as: a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions they preferably encode the systems, components and facilities described herein. For example a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements.

The term computer is to be understood as including all forms of computing device including servers, personal computers, smart phones, digital assistants and distributed computing systems.

Computer readable mediums and so forth of the type envisaged are preferably intransient. Such computer readable mediums may be operatively associated with computer based transmission facilities for the transfer of computer data. Computer readable mediums may provide data signals. Computer readable mediums preferably include magnetic disks, optical disks and other electric/magnetic and physical storage mediums as may have or find application in the industry.

Components, systems and tasks may comprise a process involving the provision of executable instructions to perform a process or the execution of executable instructions within say a processor. Applications or other executable instructions may perform method operations in different orders to achieve similar results. It is to be appreciated that the blocks of systems and methods described may be embodied in any suitable arrangement and in any suited order of operation. Computing facilities, modules, interfaces and the like may be provided in distinct, separate, joined, nested or other forms arrangement. Methods will be apparent from systems described herein and systems will be apparent from methods described herein.

The embodiments described in relation to the Figures are considered to provide for positive affirmations in an advantageous way and to provide a new and inventive type of social network. The encouragement of positive affirmations is considered to provide a shift in the context and thinking of existing systems that suffer from a number of disadvantages.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’, ‘or’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1. A computer implemented social communications system comprising: a message facility configured to encourage the creation of positive messages that provide affirmation or appreciation messages from system users; the message facility being configured to limit the creation of negative messages from the system users that would denigrate the system users or external parties; the message facility including a forms facility for assisting the system users with the construction of the positive messages

2. A computer implemented social communications system as claimed in claim 1 including a calculation facility for calculating scores relating to the positive messages sent by the system users using the message facility.

3. A computer implemented social communications system as claimed in claim 2 including a display facility for displaying the scores relating to the positive messages sent by the system users.

4. A computer implemented social communications system as claimed in claim 1 including a calculation facility for calculating scores relating to the number of unnoticed associated users that are associated with each system user; each unnoticed associated user being unnoticed by the system user for a predetermined period due to no positive messages being sent by the system user to the unnoticed associated user.

5. A computer implemented social communications system as claimed in claim 4 including a display facility for displaying the number of unnoticed associated users, associated with each system user, to the system user.

6. A computer implemented social communications system as claimed in claim 1 including a calculation facility for calculating trending scores for each system user, the trending scores relating to the positive messages sent by the system user using the message facility; the trending scores relating to the system users associated with each system user who have sent the most messages.

7. A computer implemented social communications system as claimed in claim 1 including a calculation facility for calculating trending scores for each system user relating to the positive messages sent by the system users using the message facility; the trending scores relating to the system users associated with each system user who have received the most messages.

8. A computer implemented social communications system as claimed in claim 1 including an encouragement facility that proactively sends the system users messages seeking the creation of positive messages.

9. A computer implemented social communications system as claimed in claim 1 wherein the forms facility provides the ability for a user to select an introductory set of words that that provide an introduction to a positive affirmation or appreciation message.

10. A computer implemented social communications system as claimed in claim 1 including a selector providing the ability for a user to select an image or video to form part of the positive affirmation or appreciation message.

11. A computer implemented social communications system as claimed in claim 10 wherein the forms facility is configured to tailor the affirmation or appreciation message based on data associated with a selected image or video.

12. A computer implemented social communications system for number of system users, the system including a calculation facility for calculating scores relating to the number of unnoticed associated users that are associated with each system user, each unnoticed associated user associated with a system user, being unnoticed by the system user.

13. A computer implemented social communications system as claimed in claim 12 wherein each unnoticed associated user associated with each system user, is unnoticed by the system user for a predetermined period of time due to no positive messages being sent by the system user to the unnoticed associated user.

14. A computer implemented social communications system as claimed claim 12 wherein associated users of a system user constitute electronic ‘friends’ of the system user, the associated users having accepted a ‘friend’ request.

15. A computer implemented social communications system as claimed in claim 12 wherein an unnoticed associated user of each system user is defined as being unnoticed for a predetermined period of time, due to no positive messages being sent by the system user to the unnoticed associated user.

16. A computer implemented social communications system as claimed in claim 15 wherein the predetermined period of time is 1 week.

17. (canceled)

18. (canceled).

19. A computer implemented social communications method comprising: encouraging the creation of positive messages, with the use of a message facility, to provide affirmation or appreciation messages from users; the method including limiting the creation or transmission of negative messages from the users, the negative messages operating to denigrate the users or other people; and using a forms facility to assist the users with the construction of the positive messages.

20. (canceled)

21. (canceled)

22. A computer implemented social communications method as claimed in claim 19 including calculating scores relating to the number of unnoticed associated users associated with each user; each unnoticed associated user being unnoticed by the user for a predetermined period due to no positive messages being sent by the user to the unnoticed associated user.

23. A computer implemented social communications method as claimed in claim 19 including displaying the number of unnoticed associated users, associated with each system user, to the user.

24.-50. (canceled)
